(19) United States
(12) Patent Application Publication
(10) Pub. No.: US 2013/0138320 A1
(43) Pub. Date: May 30, 2013

(54) VEHICLE CONTROL DEVICE, VEHICLE CONTROL SYSTEM AND TRAFFIC CONTROL SYSTEM

(71) Applicant: Makoto Aso, Mishima-shi (JP)

(72) Inventor: Makoto Aso, Mishima-shi (JP)

(73) Assignee: TOYOTA JIDOSHA KABUSHIKI KAISHA, Toyota-shi, Aichi-ken (JP)

(21) Appl. No.: 13/816,015

(22) PCT Filed: Aug. 1, 2011
(86) PCT No.: PCT/IB2011/001769

§ 371 Date: Feb. 8, 2013

(30) Foreign Application Priority Data
Aug. 9, 2010 (JP) 2010-178980

(51) Int. Cl. G08G 1/00

(52) U.S. Cl. CPC G08G 1/00
USPC 701/96; 701/117; 701/118

(57) ABSTRACT

A vehicle control device, a vehicle control system and a traffic control system are provided, in which it is possible to execute generating a parameter associated with a driving state of a vehicle, the parameter being variable on the basis of acquired predetermined information, and predetermined control for carrying out at least one of drive control over the vehicle based on the parameter and provision of information to a driver to assist achieving the parameter with driving operation. The predetermined information is the percentage of predetermined vehicles that are able to execute the predetermined control.

### BACKGROUND OF THE INVENTION

1. Field of the Invention

The invention relates to a vehicle control device, a vehicle control system and a traffic control system.

2. Description of Related Art

It has been attempted to reduce or avoid traffic congestion so far. Japanese Patent Application Publication No. 2009-262862 (JP-A-2009-262862) describes the technique of a drive control system. The drive control system includes traffic state acquisition means that acquires a traffic state including a vehicle density on a road on which a vehicle travels and drive control means that executes vehicle drive control so that an inter-vehicle distance reduces as the vehicle density on the road approaches a critical density.

There is still room for a study of setting an appropriate parameter associated with a vehicle driving state. For example, it may be presumed that the value of an appropriate parameter in control varies depending on the percentage of vehicles that execute control for reducing traffic congestion.

### SUMMARY OF THE INVENTION

The invention provides a vehicle control device, vehicle control system and traffic control system that are able to set an appropriate parameter associated with a vehicle driving state.

An aspect of the invention provides a vehicle control device. The vehicle control device includes: a parameter generating unit that is configured to generate a parameter associated with a driving state of a vehicle, the parameter being variable on the basis of acquired predetermined information; and a controller that is configured to execute predetermined control for carrying out at least one of drive control over the vehicle based on the parameter and provision of information to a driver to assist achieving the parameter with driving operation, wherein the predetermined information is the percentage of predetermined vehicles that are equipped with the parameter generating unit and the controller.

In addition, in the vehicle control device, the percentage of the predetermined vehicles may be based on the penetration rate of the predetermined vehicles.

In addition, in the vehicle control device, the percentage of the predetermined vehicles may be an estimated or detected percentage of the predetermined vehicles in vehicles that are actually traveling on a road.

In the vehicle control device, the parameter may be a value associated with an inter-vehicle distance between a host vehicle and a vehicle that travels immediately ahead of the host vehicle.

In addition, in the vehicle control device, the parameter generating unit may be configured to generate a target value associated with the inter-vehicle distance on the basis of the density of vehicles that travel on a road and the percentage of the predetermined vehicles, and the target value when the vehicle density is high may be larger than the target value when the vehicle density is low.

In addition, in the vehicle control device, the parameter generating unit may be configured to calculate a first target value, which is a target of a value associated with the inter-vehicle distance, on the basis of the vehicle density, and may be configured to generate the target value by guarding the first target value with an upper limit value that is variable on the basis of the percentage of the predetermined vehicles.

In addition, in the vehicle control device, a correlation between the percentage of the predetermined vehicles and the upper limit value may be based on a correlation between the percentage of the predetermined vehicles in vehicles that travel on a road and a traffic flow at which vehicles are travelable on the road when each of the predetermined vehicles travels while keeping the value associated with the inter-vehicle distance.

In addition, in the vehicle control device, the upper limit value when the percentage of the predetermined vehicles is high may be smaller than the upper limit value when the percentage of the predetermined vehicles is low.

In addition, in the vehicle control device, the parameter generating unit may be configured to generate a target value, which is the value associated with the inter-vehicle distance, as the parameter, and each of the predetermined vehicles may be configured to be able to acquire information about deceleration of a preceding predetermined vehicle, which is at least one of the predetermined vehicles that travel ahead of the host vehicle, from the preceding predetermined vehicle to decelerate the host vehicle in synchronization with the deceleration of the preceding predetermined vehicle on the basis of the information about the deceleration, and the target value when the percentage of the predetermined vehicles is high may be smaller than the target value when the percentage of the predetermined vehicles is low.

In addition, in the vehicle control device, the controller may be configured to execute feedback control, as the drive control, based on a relative vehicle speed with respect to a vehicle that travels immediately ahead of a host vehicle so as to bring a value associated with an inter-vehicle distance between the host vehicle and the vehicle that travels immediately ahead of the host vehicle to a predetermined value, and the parameter may be a feedback gain of the feedback control, and the feedback gain when the percentage of the predetermined vehicles is high may be larger than the feedback gain when the percentage of the predetermined vehicles is low.

Another aspect of the invention provides a vehicle control system. The vehicle control system includes: a traffic control system that is configured to be installed on a road and that is configured to generate a parameter associated with a driving state of a vehicle, the parameter being variable on the basis of acquired predetermined information; and a vehicle control device that is configured to acquire the parameter from the traffic control system, and that is configured to execute predetermined control for carrying out at least one of drive control over the vehicle based on the parameter and provision of information to a driver to assist achieving the parameter with driving operation, wherein the predetermined information is the percentage of predetermined vehicles that execute the predetermined control.

Further another aspect of the invention provides a traffic control system. The traffic control system includes: a parameter generating unit that is configured to be installed on a road and that is configured to generate a parameter associated with a driving state of a vehicle, the parameter being variable on the basis of acquired predetermined information; and a parameter providing unit that is configured to provide the parameter to predetermined vehicles that execute predetermined control for carrying out at least one of drive control over the vehicle based on the parameter and provision of information to a driver to assist achieving the parameter with driving operation, wherein the predetermined information is the percentage of the predetermined vehicles.

Yet further another aspect of the invention provides a vehicle control device. The vehicle control device includes: a target value generating unit that is configured to generate a target value associated with an inter-vehicle distance between a host vehicle and a vehicle that travels immediately ahead of the host vehicle, the parameter being variable on the basis of acquired predetermined information; and a controller that is configured to execute predetermined control, which is drive control over the host vehicle based on the target value, wherein the predetermined information includes at least one of information associated with weather, information associated with landform and information associated with a state of vehicles on a road.

In addition, in the vehicle control device, the information associated with weather may include information associated with the friction coefficient of a road surface.

In addition, in the vehicle control device, the information associated with a state of vehicles on a road may include at least one of the number of vehicles that travel ahead of the host vehicle and that do not execute the predetermined control, the speed of the vehicles on the road, the density of the vehicles on the road, the percentage of large-sized vehicles in the vehicles on the road and a lane position on the road on which the host vehicle travels.

The vehicle control devices according to the aspects of the invention are able to execute generating a parameter associated with a driving state of a vehicle, the parameter being variable on the basis of acquired predetermined information, and predetermined control for carrying out at least one of drive control over the vehicle based on the parameter and provision of information to a driver to assist achieving the parameter with driving operation. The predetermined information is the percentage of predetermined vehicles that are able to execute the predetermined control. With the vehicle control devices according to the aspects of the invention, it is advantageous that the parameter is generated on the basis of the percentage of predetermined vehicles to thereby make it possible to appropriately set a parameter associated with a driving state of a vehicle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart that shows the operations of a vehicle system according to a first embodiment of the invention;

FIG. 2 is a flowchart that shows the operations of an infrastructure system according to the first embodiment;

FIG. 3 is a block diagram that shows a vehicle control system according to the first embodiment;

FIG. 4 is a view for illustrating the infrastructure system according to the first embodiment;

FIG. 5 is a graph that shows the image of absorbing propagation of deceleration according to the first embodiment;

FIG. 6 is a graph that shows the correlation between an inter-vehicle time and a traffic flow and traffic congestion delayed time according to the first embodiment;

FIG. 7 is a graph that shows the correlation between the percentage of system-equipped vehicles and inter-vehicle time and a traffic flow and traffic congestion delayed time according to the first embodiment;

FIG. 8 is a graph that shows an upper limit value of a target inter-vehicle time according to the first embodiment;

FIG. 9 is a view for illustrating an inter-vehicle distance based on a target inter-vehicle time according to the first embodiment;

FIG. 10 is a view for illustrating provision of information based on a target inter-vehicle time according to the first embodiment;

FIG. 11 is a graph for illustrating a traffic congestion critical state according to the first embodiment;

FIG. 12 is a block diagram that shows a vehicle control system according to a first alternative embodiment to the first embodiment;

FIG. 13 is a block diagram that shows a vehicle control system according to a second alternative embodiment to the first embodiment;

FIG. 14 is a view for illustrating calculation of a traffic flow and the percentage of system-equipped vehicles through inter-vehicle communication according to the second alternative embodiment to the first embodiment;

FIG. 15 is a block diagram that shows a vehicle control system according to a second embodiment of the invention;

FIG. 16 is a view that shows a state where general vehicles and system-equipped vehicles mixedly travel according to the second embodiment;

FIG. 17 is a view that shows a state at the time of a start of coordinated deceleration control according to the second embodiment;

FIG. 18 is a view for illustrating movements of vehicles in which coordinated deceleration control is executed according to the second embodiment;

FIG. 19 is a graph that shows propagation of deceleration when system-equipped vehicles and general vehicles mixedly travel according to the second embodiment;

FIG. 20 is a block diagram that shows a vehicle control system according to a third embodiment of the invention;

FIG. 21 is a graph for illustrating a speed propagation ratio according to the third embodiment;

FIG. 22 is a graph that shows the correlation between the percentage of system-equipped vehicles and a feedback gain according to the third embodiment; and

FIG. 23 is a table that shows the correlation between a factor and a required inter-vehicle time according to a fourth embodiment of the invention.

### DETAILED DESCRIPTION OF EMBODIMENTS

Hereinafter, a vehicle control device, a vehicle control system and a traffic control system according to embodiments of the invention will be described with reference to the accompanying drawings. Note that the aspects of the invention are not limited to the embodiments. In addition, components in the following embodiments encompass the ones that can be easily conceived by persons skilled in the art and the ones that are substantially equivalent to the components.

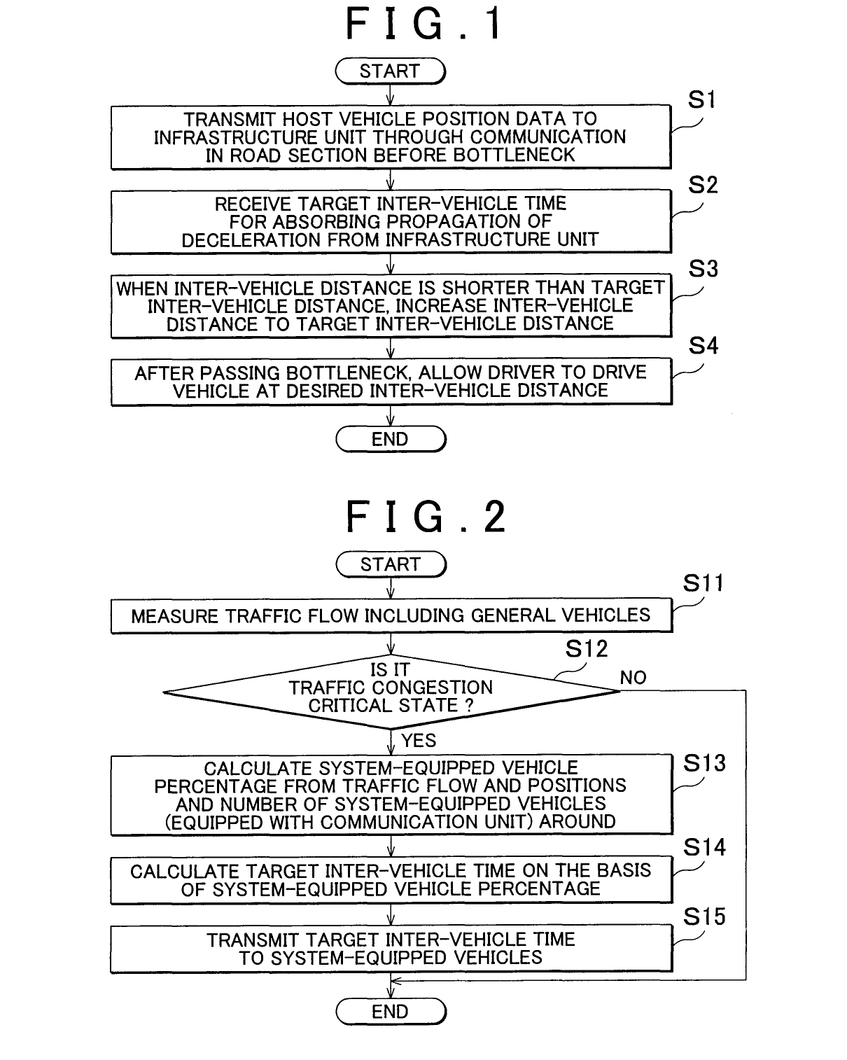

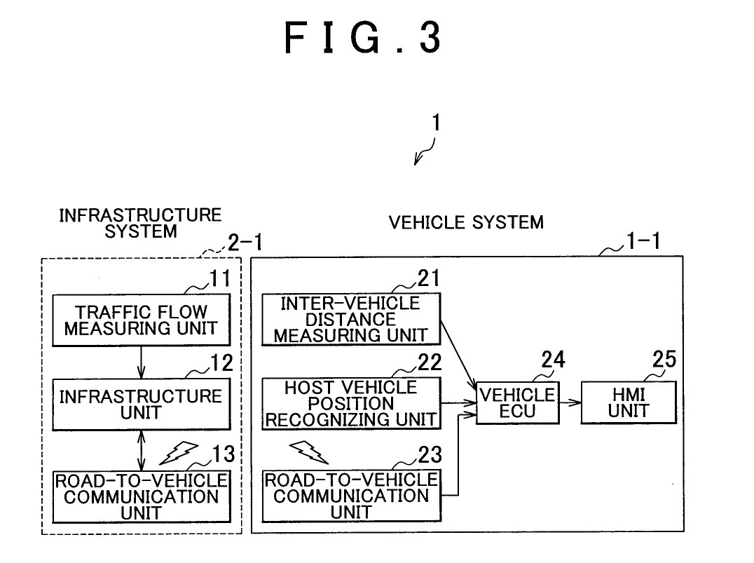

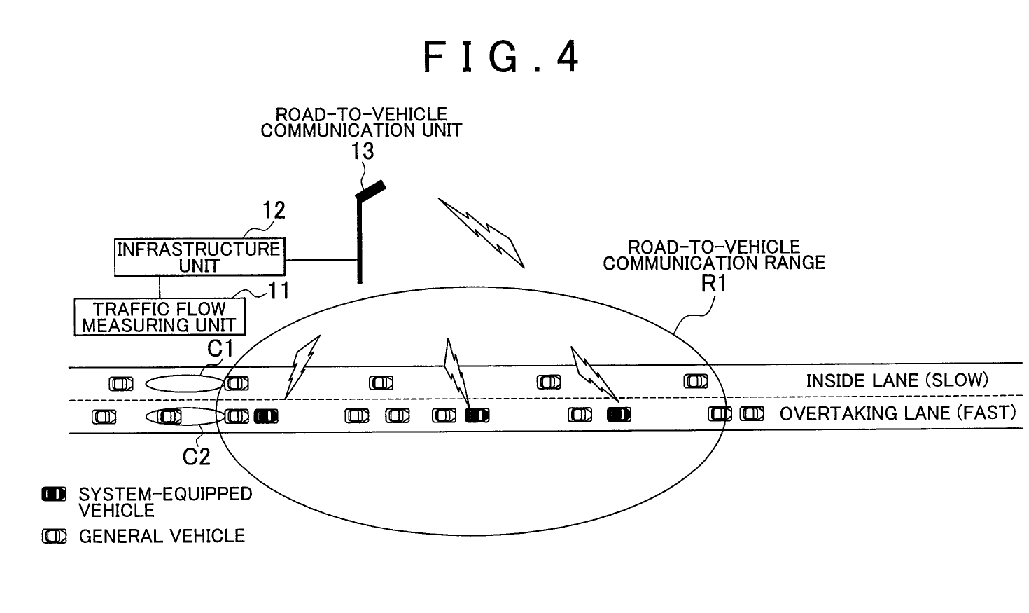

A first embodiment will be described with reference to FIG. 1 to FIG. 11. The first embodiment relates to a vehicle control device, a vehicle control system and a traffic control system. FIG. 1 is a flowchart that shows the operations of a vehicle system according to the first embodiment. FIG. 2 is a flowchart that shows the operations of an infrastructure system according to the first embodiment. FIG. 3 is a block diagram that shows a vehicle control system according to the first embodiment. FIG. 4 is a view for illustrating the infrastructure system.

The vehicle control system 1 according to the first embodiment functions as a traffic congestion reduction system. The vehicle control system 1 acquires the percentage of vehicles equipped with the vehicle system 1-1 in vehicles that travel around a bottleneck, and changes an inter-vehicle distance target on the basis of the percentage of the system-equipped vehicles. The inter-vehicle distance target when the percentage of the system-equipped vehicles is high is shorter than the inter-vehicle distance target when the percentage of the system-equipped vehicles is low. With the vehicle control system 1 according to the first embodiment, traffic congestion may be eliminated in consideration of a balance between a minimum required traffic flow and the effect of absorbing propagation of deceleration.

As shown in FIG. 3, the vehicle control system 1 according to the first embodiment includes the vehicle system 1-1 and an infrastructure system 2-1. The vehicle system 1-1 is able to function as a vehicle control device that controls a vehicle. The vehicle system 1-1 is equipped for a vehicle as a vehicle control device to control the vehicle. The infrastructure system 2-1 is a traffic control system that is installed on a road that serves as a traffic infrastructure. The infrastructure system 2-1 is, for example, arranged on a road, a roadside, or the like. The infrastructure system 2-1 includes a traffic flow measuring unit 11, an infrastructure unit 12 and a road-to-vehicle communication unit 13. In addition, the vehicle system 1-1 includes an inter-vehicle distance measuring unit 21, a host vehicle position recognizing unit 22, a road-to-vehicle communication unit 23, a vehicle ECU 24 and a human machine interface (HMI) unit 25.

The traffic flow measuring unit 11 measures the traffic flow of vehicles that travel on the road. As shown in FIG. 4, the traffic flow measuring unit 11 measures the number of vehicles that pass through measuring points C1 and C2 provided for respective lanes of the road per unit time to thereby measure the traffic flow of the road. FIG. 4 shows a limited highway, such as an expressway, having one of each of an inside lane and an overtaking lane. The traffic flow measuring unit 11 measures the number of vehicles per unit time at each of the measuring point C1 of the inside lane and the measuring point C2 of the overtaking lane to thereby measure the traffic flow of each lane and the total traffic flow of the limited highway. Note that the traffic flow measuring unit 11 may further has the function of measuring the speed and length of a passing vehicle.

The infrastructure unit 12 calculates the percentage of vehicles equipped with the vehicle system 1-1 according to the first embodiment, which functions as a traffic congestion reduction system. In the following description, the vehicles equipped with the vehicle system 1-1 are referred to as “system-equipped vehicles”. The system-equipped vehicles according to the first embodiment correspond to predetermined vehicles. Note that the system-equipped vehicles include vehicles that are able to execute control similar to that executed by the vehicle system 1-1 according to the first embodiment irrespective of whether vehicles are of the same type, whether vehicles are made by the same maker, or the like. In the first embodiment, the infrastructure system 2-1 generates a parameter that is variable on the basis of the percentage of the system-equipped vehicles. Here, the system-equipped vehicles include all the vehicle that are able to acquire a parameter from the infrastructure system 2-1 and carry out at least one of drive control over the vehicle based on the parameter and provision of information to a driver to assist achieving the parameter with driving operation.

The “percentage of the system-equipped vehicles” is the percentage of the number of system-equipped vehicles with respect to the number of vehicles including the system-equipped vehicles, and may be, for example, the percentage of the number of system-equipped vehicles that travel in a predetermined road section with respect to the number of all the vehicles that travel in the predetermined road section. The infrastructure unit 12 calculates the percentage of the system-equipped vehicles on the basis of the traffic flow of the road, measured by the traffic flow measuring unit 11, and information acquired through road-to-vehicle communication with each system-equipped vehicle. The percentage of the system-equipped vehicles according to the first embodiment corresponds to predetermined information.

As will be described later, each system-equipped vehicle transmits information about the current position, travel direction, travel speed, and the like, of the host vehicle to the infrastructure system 2-1 by the road-to-vehicle communication unit 23. The infrastructure unit 12 is, for example, able to calculate the percentage of the system-equipped vehicles on the basis of the number of system-equipped vehicles present in a region R1 in which road-to-vehicle communication is available on a limited highway and the number of all the vehicles present in the region R1. The number of all the vehicles present in the region R1 is calculated on the basis of the traffic flow measured by the traffic flow measuring unit 11. In addition, the infrastructure unit 12 is able to calculate the percentage of the system-equipped vehicles on each lane. The infrastructure unit 12 is able to determine which lane each system-equipped vehicle is traveling, the inside lane or the overtaking lane, on the basis of the current position of the system-equipped vehicle. The infrastructure unit 12 calculates the percentage of the system-equipped vehicles on each lane on the basis of the determined results.

The road-to-vehicle communication unit 13 is a communication unit that carries out communication between each vehicle system 1-1 and the infrastructure system 2-1. The road-to-vehicle communication unit 13 receives a signal transmitted from the road-to-vehicle communication unit 23 of each vehicle system 1-1. In addition, a signal transmitted from the road-to-vehicle communication unit 13 is received by the road-to-vehicle communication unit 23 of each vehicle system 1-1. In this way, each vehicle system 1-1 and the infrastructure system 2-1 are able to carry out bidirectional communication.

The inter-vehicle distance measuring unit 21 of each vehicle system 1-1 is able to measure a value associated with the inter-vehicle distance between the host vehicle and a vehicle immediately ahead of the host vehicle. The inter-vehicle distance measuring unit 21 is able to measure the inter-vehicle distance and relative vehicle speed between the host vehicle and a vehicle immediately ahead of the host vehicle. The inter-vehicle distance measuring unit 21 may be, for example, a sensor, such as a laser radar sensor and a millimeter-wave radar sensor, mounted at the front of each vehicle.

The host vehicle position recognizing unit 22 recognizes the position of the host vehicle. The host vehicle position recognizing unit 22 may be, for example, a navigation system that has a GPS unit and map data. The GPS unit includes a GPS receiver, a geomagnetic sensor, a distance sensor, a beacon sensor, a gyro sensor, and the like. The host vehicle position recognizing unit 22 acquires the position and azimuth (travel direction) of the host vehicle from the GPS unit. The map data include information about roads (coordinates, straight road, gradient, curve, expressway, the number of lanes, tunnel, sag, and the like). The host vehicle position recognizing unit 22 is able to acquire information about the road, on which the host vehicle is traveling, from the map data on the basis of the position of the host vehicle, acquired from the GPS unit. The host vehicle position recognizing unit 22, for example, acquires information about a current position on the road on which the host vehicle is traveling and information about a position ahead of the host vehicle from the map data.

The road-to-vehicle communication unit 23 is a counterpart of the road-to-vehicle communication unit 13 of the infrastructure system 2-1, and is a communication device that carries out communication between each vehicle system 1-1 and the infrastructure system 2-1.

The vehicle ECU 24 is an electronic control unit. The vehicle ECU 24 is connected to the inter-vehicle distance measuring unit 21, the host vehicle position recognizing unit 22 and the road-to-vehicle communication unit 23. A signal that indicates the value associated with the inter-vehicle distance, which is measured by the inter-vehicle distance measuring unit 21, is output to the vehicle ECU 24. In addition, a signal that indicates the position and azimuth of the host vehicle, which are recognized by the host vehicle position recognizing unit 22, and information about a road, which is acquired from the map data, are output to the vehicle ECU 24. The vehicle ECU 24 communicates information with the infrastructure system 2-1 via the road-to-vehicle communication unit 23.

In road-to-vehicle communication, each vehicle ECU 24 transmits identification information, travel information, communication standard information, and the like. The identification information includes a source vehicle ID and a vehicle group ID to which the source vehicle belongs. The travel information is measured value information about host vehicle traveling, such as a current position, a travel direction (azimuth), a travel speed, a travel acceleration, a jerk, an inter-vehicle distance and an inter-vehicle time. The communication standard information is based on a predetermined rule, and, for example, includes flags that indicate greeting information and transfer information.

The HMI unit 25, for example, provides information to a driver. The HMI unit 25, for example, includes a display, a speaker, or the like, provided in a vehicle cabin. The HMI unit 25 guides the driver by audio information, graphic information, character information, or the like, so as to achieve a target inter-vehicle time transmitted from the infrastructure system 2-1. For example, the HMI unit 25 provides the driver with information about desirable driving operation that is selected from among keeping the current inter-vehicle distance, reducing the inter-vehicle distance from the current inter-vehicle distance and increasing the inter-vehicle distance from the current inter-vehicle distance on the basis of a target inter-vehicle time and an actual inter-vehicle time. The HMI unit 25 provides such information to assist achieving a target value with driving operation.

The vehicle control system 1 according to the first embodiment adjusts the target inter-vehicle time of each system-equipped vehicle to reduce traffic congestion or ease traffic congestion. On a limited highway, or the like, there is a bottleneck point at which traffic congestion easily occurs. The bottleneck point is, for example, a point, such as a sag, at which a vehicle easily decelerates because of a gradient. At the bottleneck point, a decelerating shock wave may occur. In the decelerating shock wave, following vehicles catch up with decelerated preceding vehicles one after another, and deceleration propagates to the following vehicles while a decrease in speed is amplified. The decelerating shock wave causes traffic congestion, so it is desirable to be able to absorb or cut off propagation of speed.

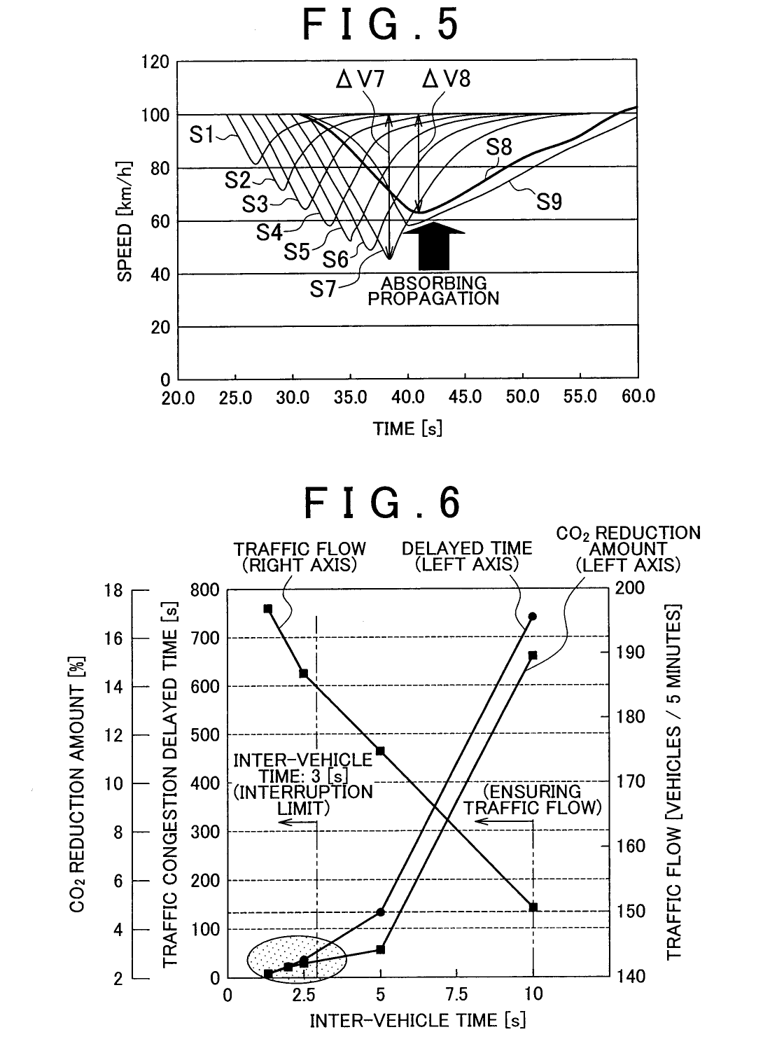

In the first embodiment, the infrastructure system 2-1 adjusts the target inter-vehicle time of each system-equipped vehicle to cause the system-equipped vehicle to absorb propagation of deceleration. FIG. 5 is a graph that shows the image of absorbing propagation of deceleration. In FIG. 5, the abscissa axis represents time, and the ordinate axis represents the travel speed of a vehicle. The reference signs S1 to S9 indicate speed changes of vehicles that travel in line on a road in this order. The speed change S1 indicates a change in the speed of the leading vehicle, and the speed change S9 indicates a change in the speed of the last vehicle. The eighth vehicle is a system-equipped vehicle, and the speed change S8 indicates a change in the speed of this system-equipped vehicle. All the other vehicles are general vehicles that are not equipped with the vehicle system 1-1. FIG. 5 shows speed changes of the respective vehicles when a decrease in speed occurs in the leading vehicle, such as when the leading vehicle passes through a sag.

As shown by the speed changes S1 to S7 in FIG. 5, as the first vehicle decelerates, a decrease in speed increases and propagates to the following vehicles, and a decrease in the speed of a following vehicle increases with respect to the speed before deceleration as the following vehicle is placed closer to the last vehicle. In the first embodiment, the target inter-vehicle time of each system-equipped vehicle is an inter-vehicle time by which propagation of deceleration may be absorbed. By so doing, a speed decrease ΔV8 in the speed change S8 of the system-equipped vehicle is smaller than a speed decrease ΔV7 in the speed change S7 of the vehicle that travels immediately ahead of the system-equipped vehicle. A decrease in speed is also reduced in the speed change S9 of the vehicle that follows the system-equipped vehicle. In this way, propagation of deceleration is absorbed by each system-equipped vehicle to thereby make it possible to absorb decelerating shock wave or delay propagation of decelerating shock wave.

The target inter-vehicle time of each system-equipped vehicle is, for example, generated on the basis of the density of vehicles that travel on a road. The density of vehicles is, for example, calculated on the basis of the traffic flow of a road and a vehicle speed. The infrastructure unit 12 is able to calculate the density of vehicles on a road on the basis of the traffic flow measured by the traffic flow measuring unit 11 and the speed of a passing vehicle. The infrastructure unit 12 increases the target inter-vehicle time of each system-equipped vehicle when the calculated density is high than when the calculated density is low. By so doing, in the vehicle control system 1, in a situation that the density of vehicles is high and deceleration easily propagates, each system-equipped vehicle increases the degree of absorbing propagation of deceleration to thereby make it possible to reduce traffic congestion or ease traffic congestion. The vehicle system 1-1 provides information to assist achieving the target inter-vehicle time with driving operation to thereby function as a traffic congestion reduction system. Provision of information carried out by the vehicle system 1-1 according to the first embodiment corresponds to predetermined control.

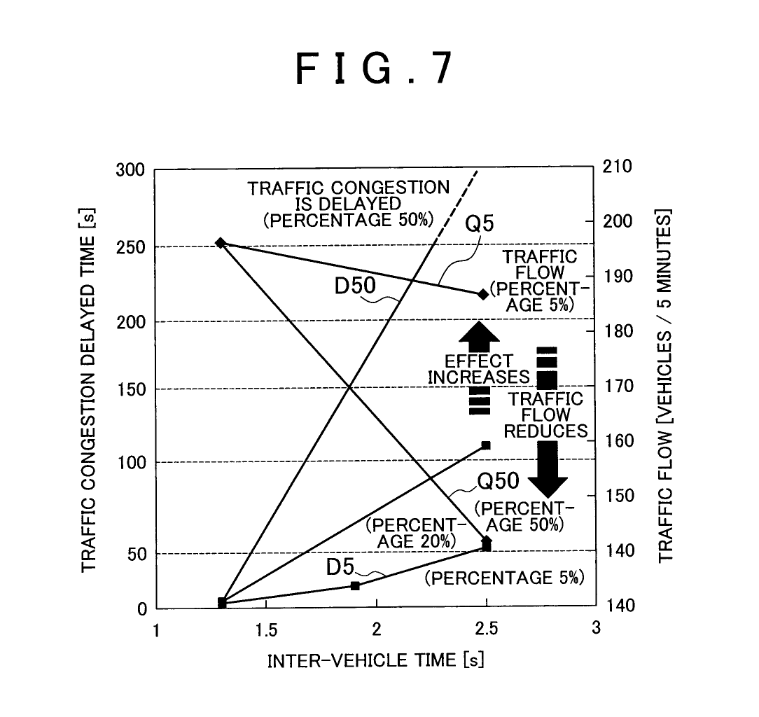

In the system that increases the inter-vehicle time to absorb propagation of deceleration to thereby ease traffic congestion, it is advantageous to increase the inter-vehicle time between a system-equipped vehicle and a vehicle immediately ahead of the system-equipped vehicle in terms of absorbing propagation of deceleration. However, as will be described below with reference to FIG. 6 and FIG. 7, increasing the inter-vehicle time may possibly reduce a traffic capacity. For example, as the percentage of system-equipped vehicles in vehicles that travel on a road increases, the vehicle density on the road when each system-equipped vehicle travels while keeping the target inter-vehicle time may decrease and this may lead to a decrease in the traffic capacity. FIG. 6 is a graph that shows the correlation between an inter-vehicle time and a traffic flow and traffic congestion delayed time. FIG. 7 is a graph that shows the correlation between the percentage of system-equipped vehicles and inter-vehicle time and a traffic flow and traffic congestion delayed time. FIG. 6 and FIG. 7 each show the correlation between the percentage of system-equipped vehicles in vehicles that travel on a road and a traffic flow at which vehicles are travelable on the road when each system-equipped vehicle travels while keeping a common inter-vehicle time.

In FIG. 6, the abscissa axis represents an inter-vehicle time, and the ordinate axis represents a CO₂ reduction amount, a traffic congestion delayed time and a traffic flow. FIG. 6 shows a CO₂ reduction amount, a traffic congestion delayed time and a traffic flow when the percentage of system-equipped vehicles is 5%. The traffic congestion delayed time is a time by which a start of traffic congestion may be delayed when each system-equipped vehicle travels while keeping a target inter-vehicle time with respect to when each system-equipped vehicle travels with the same inter-vehicle time as the inter-vehicle time of the other general vehicles. As shown in FIG. 6, as the inter-vehicle time increases, the traffic congestion delayed time increases. In correspondence with this, as the inter-vehicle time increases, the CO₂ reduction amount increases. On the other hand, as the inter-vehicle time increases, the traffic flow decreases.

In addition, the inter-vehicle time is desirably adjusted in consideration of the correlation between an inter-vehicle time and the frequency of interruption. As the inter-vehicle time increases, the frequency, at which another vehicle interrupts into between a system-equipped vehicle and its immediately preceding vehicle, increases, so it may be difficult to keep the target inter-vehicle distance. Thus, it is desirable to set an upper limit for the target inter-vehicle time so that the frequency of interruption does not become excessively high. In the first embodiment, an upper limit T1 of the target inter-vehicle time based on the frequency of interruption is set to 2.5 seconds.

In addition, a traffic congestion delaying effect and traffic capacity against an inter-vehicle time vary depending on the percentage of system-equipped vehicles. As shown in FIG. 7, the traffic congestion delayed time D50 when the percentage of system-equipped vehicles is 50% increases at a higher rate than the traffic congestion delayed time D5 when the percentage of system-equipped vehicles is 5%. On the other hand, the traffic flow Q50 when the percentage of system-equipped vehicles is 50% decreases at a higher rate than the traffic flow Q5 when the percentage of system-equipped vehicles is 5%. It is desirable to be able to achieve both the effect of absorbing propagation of deceleration and ensuring the traffic capacity.

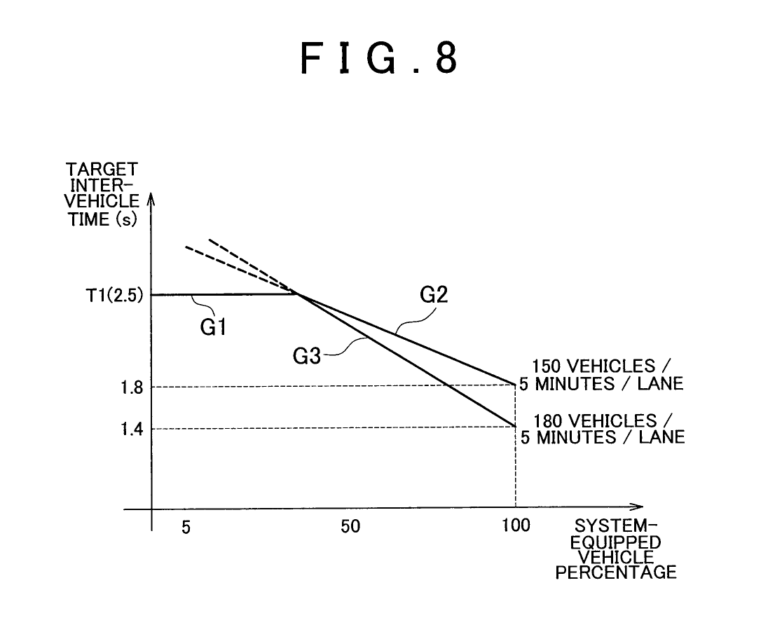

In the vehicle control system 1 according to the first embodiment, the target inter-vehicle time is variable on the basis of the percentage of system-equipped vehicles. The target inter-vehicle time is a parameter associated with a driving state of a vehicle, the parameter being generated by the infrastructure system 2-1, and is a target value of a value associated with the inter-vehicle distance between a host vehicle and a vehicle that travels immediately ahead of the host vehicle. The infrastructure system 2-1 generates a target inter-vehicle time that is variable on the basis of the percentage of system-equipped vehicles, and transmits (provides) the target inter-vehicle time to each system-equipped vehicle. A generated target inter-vehicle time is guarded by the upper limit value of the inter-vehicle time, which is based on the required traffic capacity. FIG. 8 is a graph that shows the upper limit value of the target inter-vehicle time.

In FIG. 8, the abscissa axis represents a system-equipped vehicle percentage that is the percentage of system-equipped vehicles, and the ordinate axis represents a target inter-vehicle time. The line G1 indicates the upper limit line of the inter-vehicle time, determined from the frequency of interruption. In addition, the line G2 indicates the upper limit line of the inter-vehicle time when the required traffic capacity is 150 vehicles per 5 minutes per lane, and the line G3 indicates the upper limit line of the inter-vehicle time when the required traffic capacity is 180 vehicles per 5 minutes per lane. As shown in FIG. 8, the upper limit value of the target inter-vehicle time is variable on the basis of the percentage of system-equipped vehicles. The upper limit lines G2 and G3 are, for example, determined on the basis of the correlation between an inter-vehicle time and a traffic flow shown in FIG. 6 and FIG. 7. In the upper lines G2 and G3, the upper limit value when the percentage of system-equipped vehicles is high is smaller than the upper limit value when the percentage of system-equipped vehicles is low.

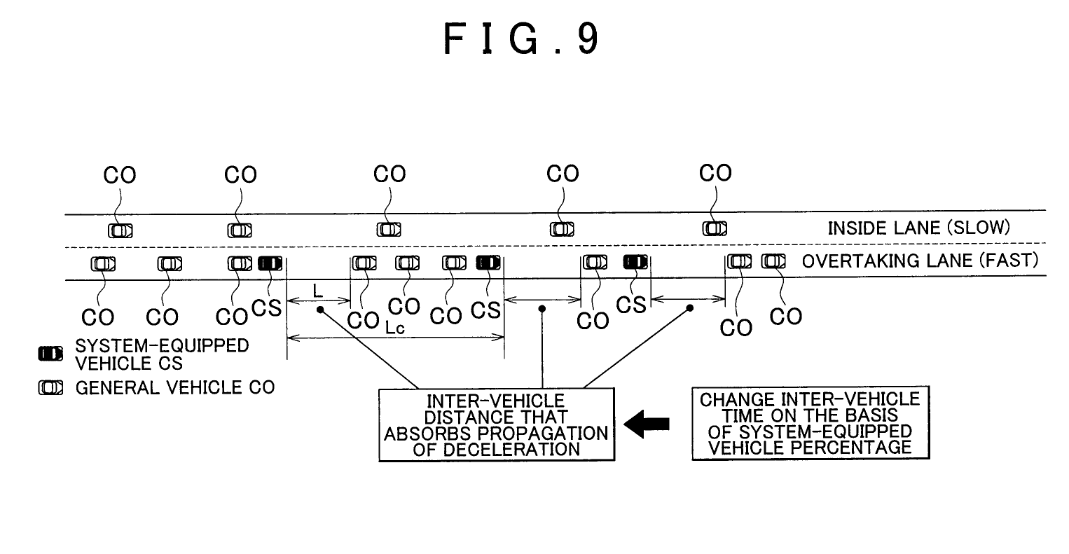

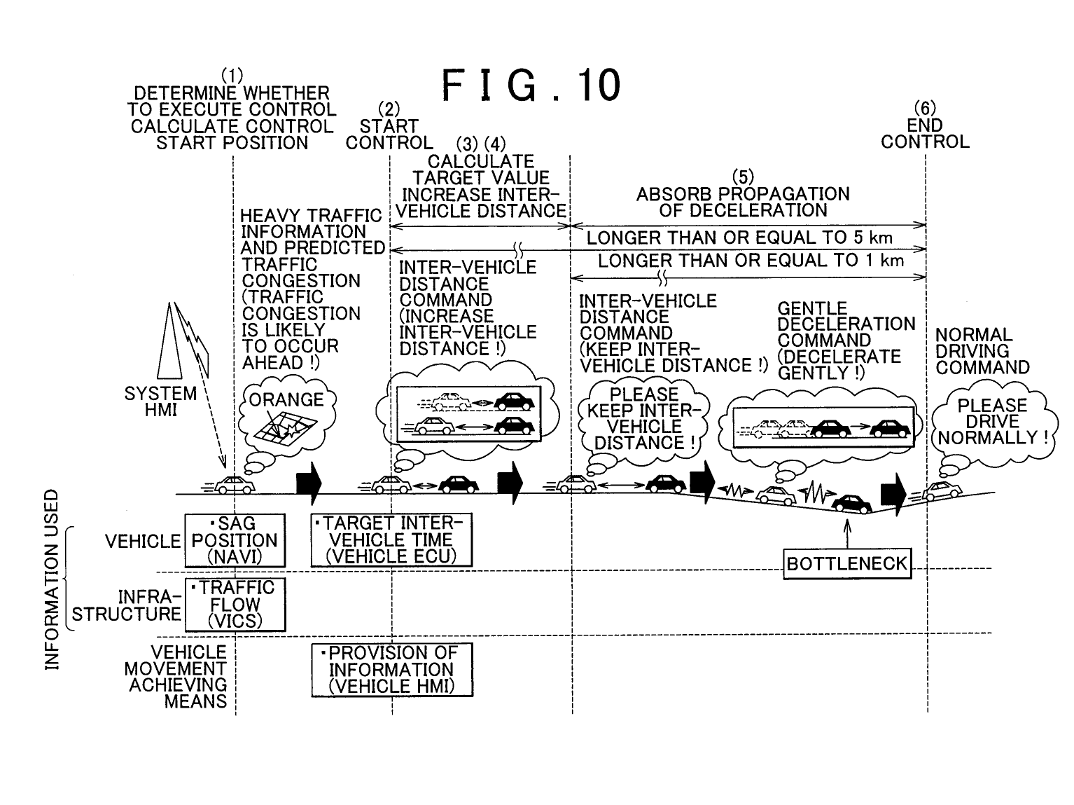

The infrastructure unit 12 guards the target inter-vehicle time on the basis of the upper limit value of the target inter-vehicle time shown in FIG. 8. For example, the infrastructure unit 12 uses the upper limit value shown in FIG. 8 to guard a target inter-vehicle time (first target value) calculated on the basis of the density of vehicles that travel on a road to thereby generate a target inter-vehicle time. The infrastructure unit 12 transmits the generated target inter-vehicle time through road-to-vehicle communication. The vehicle system 1-1 that has received the target inter-vehicle time transmitted from the infrastructure system 2-1 provides information to a driver on the basis of the target inter-vehicle time. Note that the target inter-vehicle time may be guarded by a lower limit value in addition to an upper limit value. A lower limit guard value is, for example, predetermined on the basis of a distribution of inter-vehicle times of general vehicles. FIG. 9 is a view for illustrating an inter-vehicle distance based on a target inter-vehicle time. FIG. 10 is a view for illustrating provision of information based on a target inter-vehicle time.

FIG. 9 shows a state where system-equipped vehicles CS and general vehicles CO are mixedly traveling on a limited highway. The vehicle system 1-1 of each system-equipped vehicle CS provides information to a driver so as to bring the inter-vehicle distance L to an immediately preceding vehicle to a target inter-vehicle distance based on a target inter-vehicle time. The target inter-vehicle distance is, for example, calculated on the basis of a target inter-vehicle time and a relative speed between the host vehicle and the immediately preceding vehicle. Note that the reference sign Lc indicates a headway distance from the front end of the system-equipped vehicle CS to the front end of the next system-equipped vehicle CS.

The control flow shown in FIG. 1 is, for example, executed when drive assist is turned on. As shown in FIG. 10, the vehicle system 1-1, for example, determines to execute control when the vehicle system 1-1 has detected a bottleneck ahead of the host vehicle on the basis of information acquired from the host vehicle position recognizing unit 22 or when the vehicle system 1-1 has predicted traffic congestion on the basis of information about heavy traffic ahead or information about predicted traffic congestion, acquired from a vehicle information and communication system (VICS), or the like. The vehicle system 1-1 that has determined to execute control sets a control start position. The control start position is, for example, a point at a predetermined distance before a bottleneck or a heavy traffic (traffic congestion) point.

As the control is started, initially, in step S1, the vehicle ECU 24 transmits host vehicle position data to the infrastructure unit 12 through communication in a road section before a bottleneck. The vehicle ECU 24 transmits the position coordinate data, travel direction, and the like, of the host vehicle to the infrastructure unit 12 through road-to-vehicle communication as the host vehicle position data acquired from the host vehicle position recognizing unit 22.

Subsequently, in step S2, the vehicle ECU 24 receives a target inter-vehicle time for absorbing propagation of deceleration. The vehicle ECU 24 acquires the target inter-vehicle time from the infrastructure unit 12 through road-to-vehicle communication. The vehicle ECU 24 calculates a target inter-vehicle distance from the received target inter-vehicle time.

After that, in step S3, the vehicle ECU 24 provides information to a driver to assist achieving the target inter-vehicle distance. The vehicle ECU 24 provides information on the basis of the target inter-vehicle distance calculated in step S2 and an inter-vehicle distance to the immediately preceding vehicle. The inter-vehicle distance to the immediately preceding vehicle is detected by the inter-vehicle distance measuring unit 21. For example, when the detected inter-vehicle distance is shorter than the target inter-vehicle distance, the vehicle ECU 24 provides information so as to prompt driving operation to bring the actual inter-vehicle distance close to the target inter-vehicle distance. In this case, the vehicle ECU 24 may cause the HMI unit 25 to prompt the driver to increase the inter-vehicle distance or may cause the HMI unit 25 to prompt the driver to conduct specific driving operation, such as accelerator return operation and braking operation. When the vehicle ECU 24 prompts the driver to conduct specific driving operation, the vehicle ECU 24 may vary the type of prompted operation on the basis of a target acceleration, or the like. For example, the vehicle ECU 24 may prompt the driver to conduct braking operation when a large deceleration is required to achieve the target inter-vehicle distance, and may prompt the driver to conduct accelerator return operation when a deceleration through braking operation is not required.

In addition, when the difference between the current inter-vehicle distance and the target inter-vehicle distance is small, the vehicle ECU 24 prompts the driver to drive the vehicle while keeping the current inter-vehicle distance. When the vehicle is approaching a bottleneck point or the tail end of traffic congestion, the vehicle ECU 24 causes the HMI unit 25 to prompt the driver to gently decelerate. Approaching a bottleneck point may be determined on the basis of information acquired from the host vehicle position recognizing unit 22. Approaching the tail end of traffic congestion may be determined on the basis of traffic congestion information, heavy traffic information, and the like, acquired from the VICS. For example, when the distance from the host vehicle to a bottleneck point ahead or the tail end of traffic congestion ahead is shorter than or equal to a predetermined distance, the vehicle ECU 24 prompts the driver to gently decelerate.

Then, in step S4, the vehicle ECU 24 ends drive assist with provision of information. As the host vehicle passes through a bottleneck point, the vehicle ECU 24 ends provision of information for achieving the target inter-vehicle distance. The vehicle ECU 24 informs the driver that provision of information for drive assist ends and it is not necessary to drive the vehicle while keeping the target inter-vehicle distance determined by the system from here on. By so doing, the driver starts normal driving in which the driver is not guided by the vehicle but the driver drives the vehicle with a desired inter-vehicle distance. As step S4 is executed, the control flow ends.

On the other hand, in the infrastructure unit 12, the control flow shown in FIG. 2 is executed. The control flow shown in FIG. 2 is, for example, started when the power of the infrastructure system 2-1 is turned on or through a start-up command, and is repeatedly executed at a predetermined time interval. Initially, in step S11, the traffic flow measuring unit 11 measures a traffic flow including general vehicles.

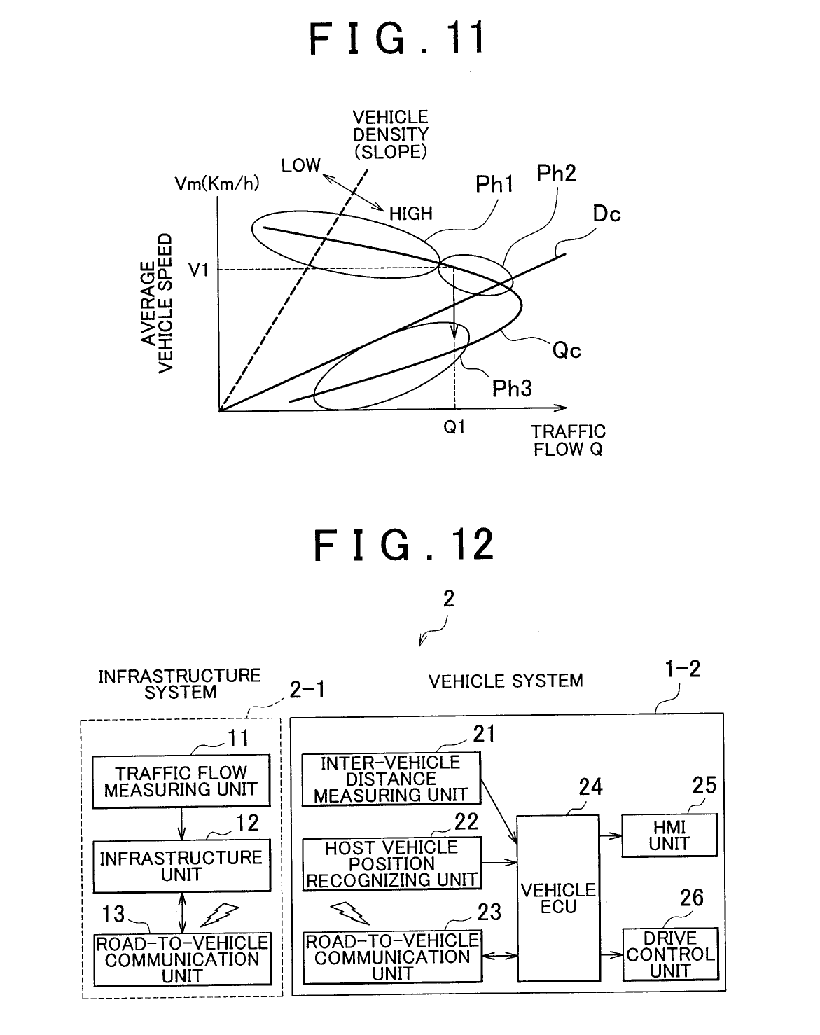

Subsequently, in step S12, the infrastructure unit 12 determines whether it is a traffic congestion critical state. The infrastructure unit 12, for example, determines whether it is a traffic congestion critical state (hereinafter, also simply referred to as “critical state”) as will be described below with reference to FIG. 11. FIG. 11 is a graph for illustrating the critical state. In FIG. 11, the abscissa axis represents a traffic flow Q, and the ordinate axis represents an average vehicle speed Vm. The traffic flow Q is the number of passing vehicles per unit time for each lane (vehicles/time•lane). That is, FIG. 11 shows the correlation between a travel speed and a traffic flow at which vehicles are travelable on a road. In FIG. 11, the slope of the line that passes through the origin indicates the vehicle density on the road. The vehicle density increases with an increase in the traffic flow Q or a reduction in the average vehicle speed Vm, and reduces with a reduction in the traffic flow Q or an increase in the average vehicle speed Vm. In addition, the reference sign Dc indicates a critical density. As the vehicle density exceeds the critical density Dc, traffic easily enters a traffic congestion state.

The reference sign Qc indicates a maximum traffic flow line. The maximum traffic flow line Qc indicates the correlation between each average vehicle speed Vm and a maximum traffic flow at which vehicles are travelable on the road. The maximum traffic flow line Qc corresponds to an average inter-vehicle time characteristic when a man drives a vehicle. The reference sign Ph1 indicates a free phase, the reference sign Ph2 indicates a critical phase, and the reference sign Ph3 indicates a traffic congestion phase. The free phase Ph1 corresponds to the range in which the vehicle density is small in the maximum traffic flow line Qc. The critical phase Ph2 corresponds to the range in which the vehicle density is larger than that of the free phase Ph1 in the maximum traffic flow line Qc and is close to the critical density Dc and smaller than the critical density Dc. The traffic congestion phase Ph3 corresponds to a range in which the vehicle density is larger than the critical density Dc in the maximum traffic flow line Qc.

As the vehicle density exceeds the critical density Dc, uniform flow becomes unstable, slight speed fluctuations propagate while growing up in a direction opposite to the travel direction of the vehicles (decelerating shock wave), and then the phase shifts into the traffic congestion phase Ph3 at a time (phase transition). For example, the state where the average vehicle speed is V1 and the traffic flow is Q1 is a state in the critical phase Ph2, that is, the critical state. When the traffic flow condition is in the critical state, the vehicle density easily exceeds the critical density Dc because of a disturbance or a further increase in traffic flow, so the traffic flow condition easily enters a traffic congestion state. For example, when shock wave that a decrease in speed propagates to following vehicles occurs at a sag, or the like, the traffic flow condition easily shifts into a traffic congestion state through phase transition.

The infrastructure unit 12 determines whether it is the critical state on the basis of the traffic flow measured in step S11 and the speed of the vehicles that travel on the road. The speed of the vehicles may be, for example, the speed of a system-equipped vehicle, acquired through road-to-vehicle communication. The infrastructure unit 12 is able to determine whether it is the critical state lane by lane and is able to determine whether it is the critical state on the basis of the total traffic flow of all the lanes in the same travel direction. For example, when it is determined whether it is the critical state lane by lane, it is only necessary that the lane on which a system-equipped vehicle is traveling is determined and then the speed of the system-equipped vehicle is used as the average speed of the lane on which the system-equipped vehicle travels. The lane on which a system-equipped vehicle is traveling may be, for example, determined on the basis of the positional information of the system-equipped vehicle and the coordinate information of the road. For each of the lanes, it is possible to determine whether it is the critical state on the basis of the speed of the lane and the traffic flow of the lane. For example, when there is at least one lane that is in the critical state, the infrastructure unit 12 makes affirmative determination in step S12. When it is determined to be a traffic congestion critical state (Yes in step S12) as a result of the determination in step S12, the process proceeds to step S13; otherwise (No in step S12), the control flow ends.

After that, in step S13, the infrastructure unit 12 calculates the percentage of system-equipped vehicles. The infrastructure unit 12 calculates the percentage of system-equipped vehicles from the traffic flow measured in step S11, the position of each system-equipped vehicle and the number of system-equipped vehicles, which are acquired through road-to-vehicle communication. The infrastructure unit 12 calculates the number of system-equipped vehicles that are traveling in a predetermined region on the road on the basis of the positional information transmitted from each system-equipped vehicle. In addition, the infrastructure unit 12 calculates the number of all the vehicles that are traveling in the predetermined region from the traffic flow measured in step S11. The percentage of system-equipped vehicles is calculated on the basis of the number of system-equipped vehicles and the number of all the vehicles in the predetermined region.

Then, in step S14, a target inter-vehicle time is calculated on the basis of the percentage of system-equipped vehicles. The infrastructure unit 12 calculates a target inter-vehicle time on the basis of the percentage of system-equipped vehicle, calculated in step S13. The infrastructure unit 12 determines a target inter-vehicle time in such a manner that the target inter-vehicle time, generated on the basis of the density of vehicles that travel on the road, is guarded by the upper limit value shown in FIG. 8. When the percentage of system-equipped vehicles is low, the upper limit T1 of the target inter-vehicle time based on the frequency of interruption is set as a guard value. In addition, when the percentage of system-equipped vehicles is high, a guard value is determined on the basis of the required traffic flow. For example, a guard value is determined so as to be able to at least ensure the current traffic flow. When the current traffic flow is 150 vehicle per 5 minutes per lane, the upper limit line G2 may be set as a guard value. Alternatively, in order to be able to ensure a further high traffic flow, for example, the upper limit line G3 may be set as a guard value instead of the upper limit line G2. As the target inter-vehicle time is calculated, the process proceeds to step S15.

In step S15, the infrastructure unit 12 transmits the target inter-vehicle time to each system-equipped vehicle. The infrastructure unit 12 transmits the target inter-vehicle time calculated in step S14 to each system-equipped vehicle through road-to-vehicle communication. As step S15 is executed, the control flow ends.

In this way, with the vehicle control system 1 according to the first embodiment, a target inter-vehicle time that is variable on the basis of the percentage of system-equipped vehicles is generated, and information is provided to a driver so as to be able to achieve the target inter-vehicle time through driving operation in each system-equipped vehicle. By so doing, propagation of deceleration is absorbed by the system-equipped vehicles to thereby make it possible to reduce traffic congestion or ease traffic congestion.

In addition, in the first embodiment, the target inter-vehicle time is determined on the basis of the required traffic flow to thereby reduce sparse or dense in a distribution of vehicles on a road and equally distribute the vehicles. The target inter-vehicle distance of each system-equipped vehicle corresponds to an inter-vehicle distance to which an average density calculated from a traffic flow and an average speed is converted on a per-vehicle basis. If all the vehicles including the system-equipped vehicles keep the target inter-vehicle distance, the vehicles are equally distributed on the road. Thus, as the percentage of system-equipped vehicles increases, the vehicle density on the road approaches a uniform density and, therefore, deceleration is hard to propagate.

In the first embodiment, the target inter-vehicle time is variable on the basis of the percentage of system-equipped vehicles; however, the configuration is not limited to it. Another target value associated with the correlation with an immediately preceding vehicle, such as a target inter-vehicle distance, may be variable on the basis of the percentage of system-equipped vehicles. For example, the infrastructure unit 12 may generate a target inter-vehicle distance, instead of a target inter-vehicle time, as a value that is variable on the basis of the percentage of system-equipped vehicles and then may transmit the generated target inter-vehicle distance to each system-equipped vehicle.

In addition, a parameter associated with a driving state different from the correlation with an immediately preceding vehicle, which is variable on the basis of the percentage of system-equipped vehicles, may be generated. For example, a target vehicle speed may be variable on the basis of the percentage of system-equipped vehicles.

In the first embodiment, the infrastructure unit 12 calculates the percentage of system-equipped vehicles on the basis of information acquired through road-to-vehicle communication; however, a method of calculating the percentage of system-equipped vehicles is not limited to this configuration. For example, the infrastructure unit 12 may acquire the percentage of system-equipped vehicles through communication with a center that provides road information, or the like, or may calculate the percentage of system-equipped vehicles on the basis of information acquired from the center.

In addition, in the first embodiment, the percentage of system-equipped vehicles is a detected percentage of system-equipped vehicles in vehicles that are actually traveling on a road; however, the configuration is not limited to it. The percentage of system-equipped vehicles may be an estimated percentage of system-equipped vehicles in vehicle that are actually traveling on a road. In addition, the percentage of system-equipped vehicles may be, for example, based on the penetration rate of system-equipped vehicles. The penetration rate is, for example, the percentage of the number of system-equipped vehicles in the number of vehicles sold or the number of vehicles registered. In addition, the percentage of system-equipped vehicles may be the percentage of system-equipped vehicles in vehicles around the host vehicle (the number of system-equipped vehicles/the number of all the vehicles). In addition, it is also applicable that a table, or the like, that shows a change over time in an assumed number of owned system-equipped vehicles is prestored in each vehicle system 1-1 and then an assumed current number of owned system-equipped vehicles, acquired from the table, is used as the percentage of system-equipped vehicles.

Next, a first alternative embodiment to the first embodiment will be described. In the first embodiment, the vehicle system 1-1 provides information to assist achieving a target inter-vehicle time with driving operation. In addition to this, the vehicle system 1-1 may be able to execute vehicle drive control based on the target inter-vehicle time. FIG. 12 is a block diagram that shows a vehicle control system 2 according to the present alternative embodiment. As shown in FIG. 12, a vehicle system 1-2 according to the present alternative embodiment includes a drive control unit 26 in addition to the HMI unit 25 according to the first embodiment. The drive control unit 26 controls the driving state of the vehicle, and controls an engine, a brake, an automatic transmission, and the like. The vehicle ECU 24 outputs a control target, such as a target acceleration, to the drive control unit 26 so as to achieve a target inter-vehicle distance corresponding to a target inter-vehicle time. The drive control unit 26 executes vehicle drive control so as to achieve the target acceleration. The vehicle drive control executed by the drive control unit 26 according to the first alternative embodiment to the first embodiment corresponds to predetermined control.

When operation for instructions to execute vehicle control for achieving the target inter-vehicle time is conducted by a driver, the vehicle ECU 24 controls the driving state of the vehicle so as to reduce the difference between the target inter-vehicle time, transmitted from the infrastructure unit 12, and an actual inter-vehicle time. The vehicle control may be, for example, executed as one of modes of adaptive cruise control (ACC). The ACC, for example, executes follow-up control and constant speed drive control. In the follow-up control, a preceding vehicle is detected by a radar, or the like, and then the host vehicle travels following the preceding vehicle so as to keep a constant inter-vehicle distance. In the constant speed drive control, the host vehicle is caused to travel at a constant vehicle speed. In the follow-up control, when the vehicle travels while keeping an inter-vehicle distance by which propagation of deceleration is absorbed, such as when the vehicle travels in a road section before a bottleneck, a target inter-vehicle distance corresponding to the target inter-vehicle time transmitted from the infrastructure unit 12 is set as a control target instead of the target inter-vehicle distance set by the driver.

When no operation for instructions to execute vehicle control for achieving the target inter-vehicle time is conducted by the driver, the vehicle ECU 24 just needs to provide information to assist achieving the target inter-vehicle time with driver's driving operation, as in the case of the first embodiment.

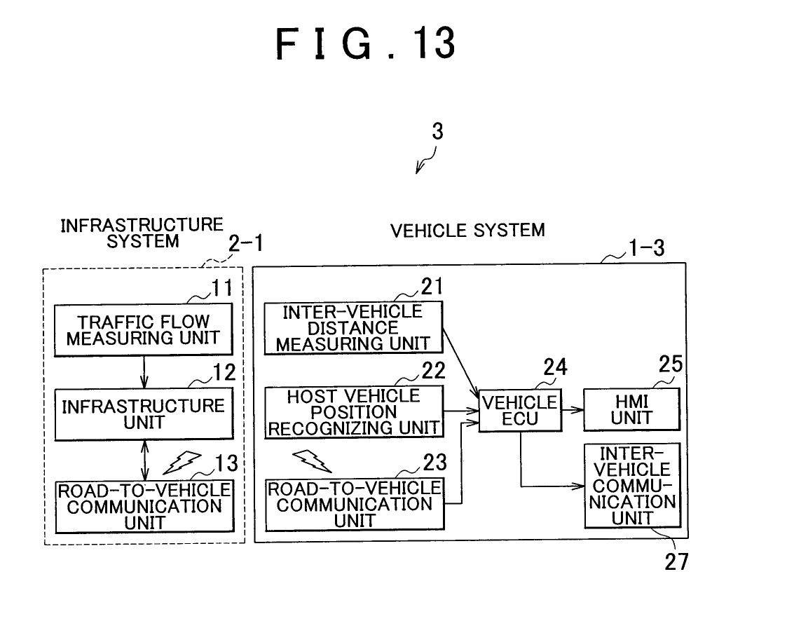

Next, a second alternative embodiment to the first embodiment will be described. In the first embodiment, the infrastructure system 2-1 measures the traffic flow, calculates the percentage of system-equipped vehicles and calculates the target inter-vehicle time; instead, the vehicle system may perform these calculations. FIG. 13 is a block diagram that shows a vehicle control system 3 according to the present alternative embodiment. As shown in FIG. 13, a vehicle system 1-3 that serves as a vehicle control device includes an inter-vehicle communication unit 27 in addition to the units of the vehicle system 1-1 according to the first embodiment. The inter-vehicle communication unit 27 carries out communication between system-equipped vehicles equipped with the vehicle system 1-3.

In inter-vehicle communication, various types of information, including identification information, driving information, control target amount information, driver operation information, vehicle specification information, communication standard information and environment information, are transmitted to the other vehicles. The identification information includes a source vehicle ID and a vehicle group ID to which the source vehicle belongs. The driving information is measured value information about traveling of the host vehicle 1, such as a current position, a travel direction (azimuth), a travel speed, a travel acceleration, a jerk, an inter-vehicle distance and an inter-vehicle time. The control target amount information is target values, input values, control command values, and the like, when an in-vehicle device controls the vehicle, and includes a target speed, a target acceleration, a target jerk, a target direction (azimuth), a target inter-vehicle time and a target inter-vehicle distance.

The driver operation information is an operation amount and input information that are operated or input from a driver, and includes an accelerator operation amount, a brake operation amount (depressing force and stroke), a winker operation (presence or absence of operation and operated direction), a steered angle, an on/off of a brake lamp, and the like. The vehicle specification information includes a vehicle weight, a maximum brake force, a maximum acceleration force, a maximum jerk, and the reaction speed and time constant of each of actuators (brake, accelerator, shift lever, and the like). The communication standard information is based on a predetermined rule, and includes flags, or the like, that indicate greeting information and transfer information. The environment information is information about a driving environment, and includes road surface information (for example, μ, gradient, temperature, wet or dry or frozen, asphalt or unpaved), wind speed, wind direction, and the like.

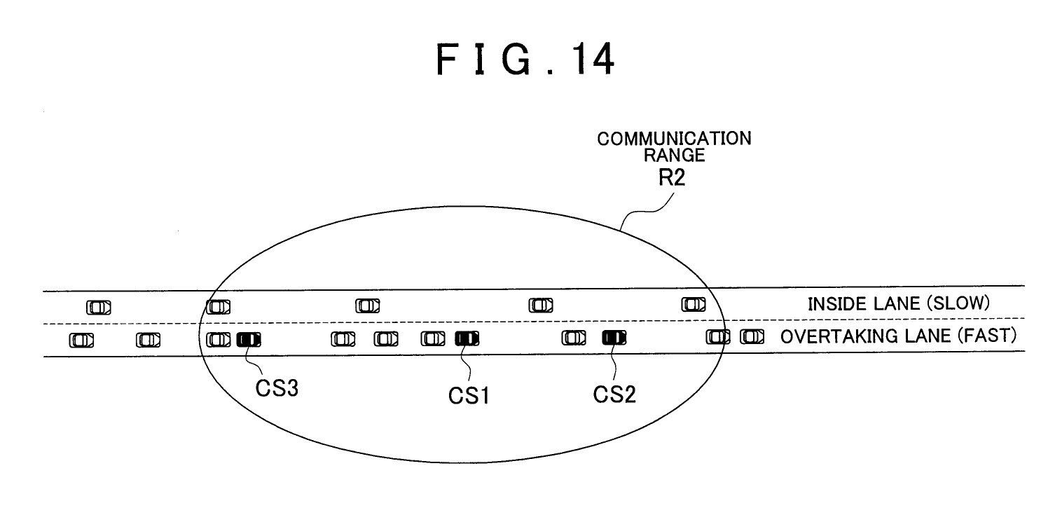

Each system-equipped vehicle causes the inter-vehicle communication unit 27 to acquire the number of surrounding system-equipped vehicles. FIG. 14 is a view for illustrating calculation of a traffic flow and the percentage of system-equipped vehicles through inter-vehicle communication. In FIG. 14, the reference sign R2 indicates the inter-vehicle communication range of a system-equipped vehicle CS1. The system-equipped vehicle CS1 acquires positional information of the other system-equipped vehicles CS2 and CS3 that travel in the communication range R2 through inter-vehicle communication. By so doing, it is possible to calculate the number of system-equipped vehicles that travel in the communication range R2. In addition, each system-equipped vehicle calculates the number of general vehicles around the host vehicle. The number of surrounding vehicles may be, for example, detected in such a manner that the number of vehicles that travel nearby or the relative positions with respect to the vehicles are detected by a sensor, such as a radar, or the number of vehicles that travel nearby or the relative positions with respect to the vehicles are detected on the basis of image data around the host vehicle, captured by a camera, or the like. When another system-equipped vehicle is traveling around the host vehicle, it is possible to discriminate between the system-equipped vehicle and the general vehicle on the basis of positional information acquired through inter-vehicle communication.

Each system-equipped vehicle transmits the number of general vehicles that travel around the host vehicle to other system-equipped vehicles through inter-vehicle communication. By so doing, the system-equipped vehicle CS1 is able to estimate the percentage of system-equipped vehicles in the communication range R2. For example, the system-equipped vehicle CS1 is able to estimate the vehicle density in the communication range R2 and the number of all the vehicles present in the communication range R2 on the basis of the number of surrounding general vehicles, transmitted from the system-equipped vehicles. The percentage of system-equipped vehicles is calculated on the basis of the estimated number of all the vehicles and the number of system-equipped vehicles in the communication range R2, which is calculated through inter-vehicle communication. The system-equipped vehicle CS1, for example, calculates the percentage of system-equipped vehicles on the basis of the number of system-equipped vehicles that are present in the communication range R2 on the same lane as that of the host vehicle and the number of all the vehicles that are present in the communication range R2 on the same lane as that of the host vehicle. Each system-equipped vehicle generates a target inter-vehicle time on the basis of the upper limit value of the target inter-vehicle time corresponding to the calculated percentage of system-equipped vehicles, and carries out provision of information to assist achieving the target inter-vehicle time.

In this way, when the percentage of system-equipped vehicles is estimated on the basis of information acquired by the vehicle system 1-3 through inter-vehicle communication, it is possible to omit the infrastructure system 2-1. That is, the vehicle system 1-3 that serves as a vehicle control device autonomously generates a parameter that is variable on the basis of the percentage of system-equipped vehicles to thereby make it possible to provide information to a driver to assist achieving the generated parameter. Note that the vehicle system 1-3 may be configured to acquire at least part of information for calculating the percentage of system-equipped vehicles from the infrastructure system 2-1 through road-to-vehicle communication. In addition, the percentage of system-equipped vehicles may be based on the penetration rate of system-equipped vehicles, the assumed number of owned system-equipped vehicles, or the like, as in the case of the first embodiment. According to the present alternative embodiment, it is possible to generate a target value that is variable on the basis of the percentage of system-equipped vehicles in an area in which no infrastructure system 2-1 is installed.

Note that the system-equipped vehicle CS1, which is able to carry out inter-vehicle communication, may use the number of general vehicles placed between the system-equipped vehicle CS1 and the immediately preceding system-equipped vehicle CS2 as a vehicle density for calculating a target inter-vehicle time instead of the value used in the first embodiment. The immediately preceding system-equipped vehicle is the system-equipped vehicle CS2 that is the closest to the host vehicle CS1 among the system-equipped vehicles that travel ahead of the host vehicle CS1 on the same lane. The number of general vehicles placed in between may be estimated on the basis of the inter-vehicle distance between the host vehicle CS1 and the immediately preceding system-equipped vehicle CS2 and the vehicle density on the road.

The vehicle system 1-3 may not only provide information to a driver to assist achieving a target inter-vehicle time with driving operation but also execute vehicle drive control based on the target inter-vehicle time. For example, as in the case of the first alternative embodiment to the first embodiment, the vehicle system 1-3 includes the drive control unit 26, and, when operation for instructions to execute vehicle control for achieving a target inter-vehicle time is conducted by a driver, vehicle control based on the target inter-vehicle time is executed; whereas, when the above operation is not conducted by the driver, it is possible to provide information to the driver.

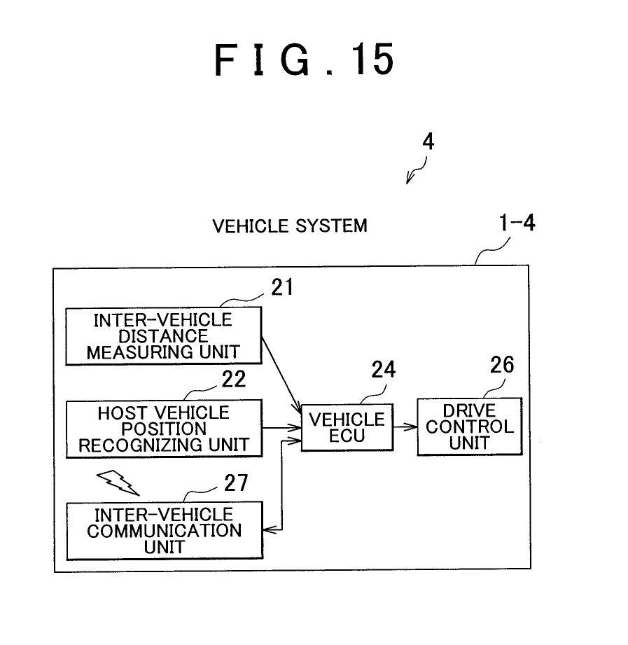

Next, a second embodiment will be described. The second embodiment will be described with reference to FIG. 15 to FIG. 19. In the second embodiment, like reference numerals denote components having functions similar to those described in the first embodiment, and the overlap description is omitted. FIG. 15 is a block diagram that shows a vehicle control system 4 according to the second embodiment.

As shown in FIG. 15, the vehicle control system 4 includes a vehicle system 1-4. The vehicle system 1-4 includes an inter-vehicle communication unit 27, and is able to estimate the percentage of system-equipped vehicles on the basis of data acquired through inter-vehicle communication. In addition, the vehicle system 1-4 includes a drive control unit 26. The vehicle system 1-4 is able to function as a vehicle control device that generates a parameter variable on the basis of the percentage of system-equipped vehicles without an infrastructure system and that executes predetermined control. Note that the vehicle control system 4 may include the same infrastructure system as the infrastructure system 2-1 according to the first embodiment and may transmit the percentage of system-equipped vehicles from the infrastructure system to the vehicle system 1-4.

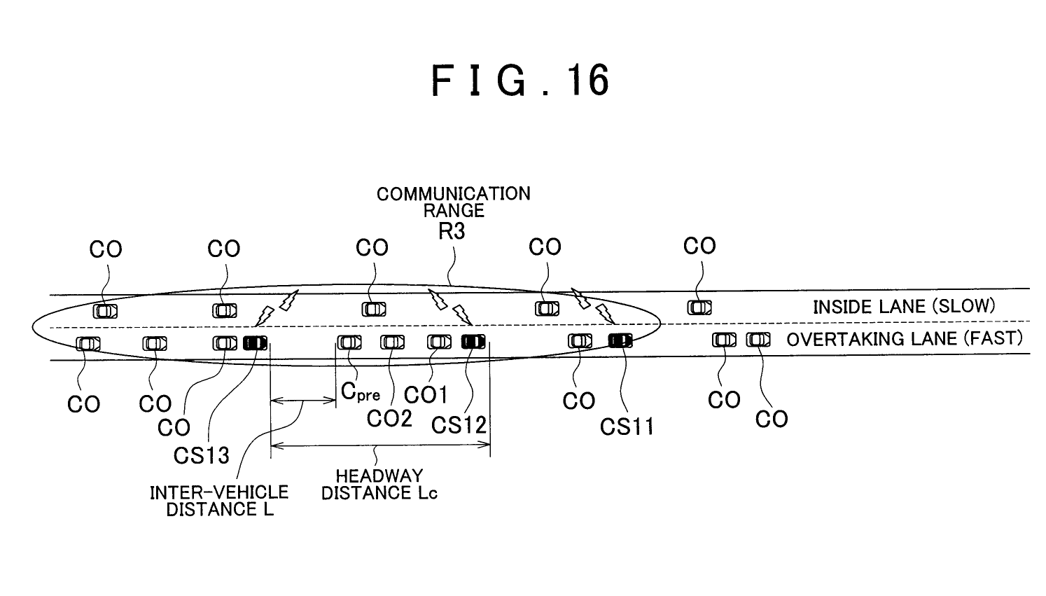

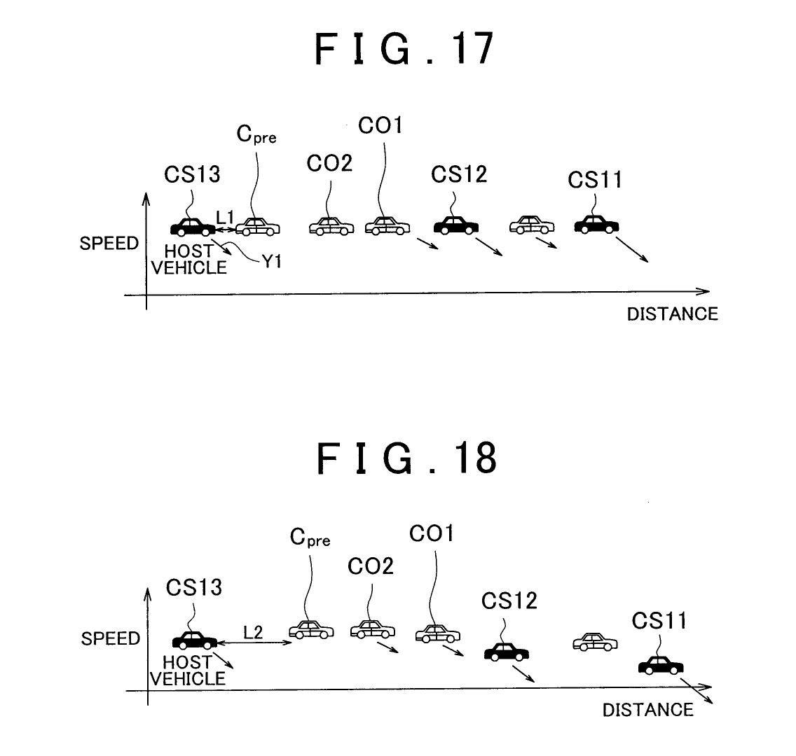

The vehicle system 1-4 is able to carry out follow-up drive in which the host vehicle travels following an immediately preceding vehicle, and, as will be described below with reference to FIG. 16 to FIG. 18, the vehicle system 1-4 is able to execute coordinated deceleration control in which information about deceleration of a preceding system-equipped vehicle is acquired from the preceding system-equipped vehicle, and the host vehicle is decelerated in synchronization with deceleration of the preceding system-equipped vehicle on the basis of the acquired information. FIG. 16 is a view that shows a state where general vehicles and system-equipped vehicles mixedly travel. FIG. 17 is a view that shows a state at the time of a start of coordinated deceleration control. FIG. 18 is a view for illustrating movements of vehicles in which coordinated deceleration control is executed.

The host vehicle CS13, which is a system-equipped vehicle equipped with the vehicle system 1-4, exchanges information with other system-equipped vehicles CS11 and CS12, which travel in a communication range R3 of the host vehicle CS13, through inter-vehicle communication. Each of the system-equipped vehicles CS11, CS12 and CS13 transmits the positional information, azimuth, travel speed, and the like, of the host vehicle to the other system-equipped vehicles. In the following description, unless otherwise specified, the vehicle system 1-4 is the vehicle system 1-4 of the host vehicle CS13, and the vehicle ECU 24 is the vehicle ECU 24 of the host vehicle CS13. The vehicle system 1-4 determines a system-equipped vehicle that travels ahead of the host vehicle CS13 on the same lane as the host vehicle CS13 on the basis of the received information. In FIG. 16, within the communication range R3, two system-equipped vehicles CS11 and CS12 are traveling ahead of the host vehicle CS13 on the lane on which the host vehicle CS13 travels. The vehicle system 1-4 recognizes that the system-equipped vehicles CS11 and CS12 are traveling ahead on the same lane.

The vehicle ECU 24 of the vehicle system 1-4 is able to execute follow-up control with respect to an immediately preceding vehicle Cpre that travels immediately ahead of the host vehicle CS13, and is able to execute coordinated deceleration control that causes the host vehicle CS13 to decelerate in coordination with the preceding system-equipped vehicles CS11 and CS12. The follow-up control and the coordinated deceleration control are, for example, executed as one of control modes of ACC. In follow-up control, the vehicle ECU 24 controls the acceleration of the host vehicle CS13 so that the inter-vehicle distance L between the host vehicle CS13 and the immediately preceding vehicle Cpre becomes a predetermined target inter-vehicle distance L. In addition, the vehicle ECU 24 controls the acceleration of the host vehicle CS13 so as to reduce the differences in speed between the preceding system-equipped vehicles CS11 and CS12 and the host vehicle CS13. The vehicle ECU 24, for example, calculates a host vehicle target acceleration aₜ, which is the target acceleration of the host vehicle CS13, by the following mathematical expression (1).

aₜ=k_{vc1}(V_{c1}−V)+k_{vc2}(V_{c2}−V)+ . . . +k_{vcN}(V_{cN}−V)+k_{aRelV}V(Vₚᵣₑ−V)+k_{aS}(Lₜ−L) (1)

In the mathematical expression (1), V is a host vehicle speed, Vₚᵣₑ is an immediately preceding vehicle speed, L is an inter-vehicle distance, k_{aRelV} is a feedback gain of a speed difference from the immediately preceding vehicle, and k_{aS} is a feedback gain of a deviation in inter-vehicle distance from the immediately preceding vehicle. In addition, k_{vc1}, . . . , k_{vcN} are feedback gains of speed differences from the preceding system-equipped vehicles, and are, for example, positive values. V_{c1}, . . . , V_{cN} are the speeds of the preceding system-equipped vehicles. In the second embodiment, the immediately preceding vehicle speed Vₚᵣₑ, which is the speed of the system-equipped vehicle ahead of the host vehicle, corresponds to information about deceleration of that system-equipped vehicle. In FIG. 16, two system-equipped vehicles travel ahead of the host vehicle CS13 within the communication range R3, so N is set to 2 in the above mathematical expression (1). The drive control unit 26 controls the acceleration of the host vehicle CS13 on the basis of the host vehicle target acceleration aₜ.

As shown in the above mathematical expression (1), the host vehicle target acceleration aₜ is calculated on the basis of not only the feedback term of follow-up control with respect to the immediately preceding vehicle Cpre (the last two terms on the right-hand side) but also the feedback terms based on the speed differences with respect to the preceding system-equipped vehicles. By so doing, as the system-equipped vehicles ahead of the host vehicle CS13 decelerate, the host vehicle target acceleration aₜ reduces synchronously, and then the drive control unit 26 reduces the acceleration of the host vehicle CS13. That is, the drive control unit 26 is able to decelerate the host vehicle CS13 in coordination with deceleration of the preceding system-equipped vehicles.

Because the host vehicle target acceleration aₜ is determined in this way, when the preceding system-equipped vehicles decelerate, the drive control unit 26 is able to decelerate the host vehicle CS13 in synchronization with a start of deceleration of the preceding system-equipped vehicles. In FIG. 17, the abscissa axis represents distances between the host vehicle CS13 and vehicles ahead of the host vehicle CS13, and the ordinate axis represents the speed of each vehicle. FIG. 17 shows a state immediately after the system-equipped vehicle CS12 following the leading system-equipped vehicle CS11 starts deceleration in coordination with deceleration of the system-equipped vehicle CS11. The obliquely downward arrows affixed to the vehicles indicate the decelerations of the vehicles, and the lengths of the arrows indicate the magnitudes of the decelerations. Immediately after the system-equipped vehicle CS12 has started deceleration, a general vehicle CO1 immediately behind the system-equipped vehicle CS12 has started deceleration; however, deceleration has not yet propagated to a general vehicle CO₂ that is two vehicles behind the host vehicle CS13 and a vehicle Cpre immediately ahead of the host vehicle CS13. On the other hand, the host vehicle CS13 has started deceleration in coordination with deceleration of the preceding system-equipped vehicles CS11 and CS12 as indicated by the arrow Y1. Thus, the inter-vehicle distance L between the host vehicle CS13 and the immediately preceding vehicle Cpre starts to increase.

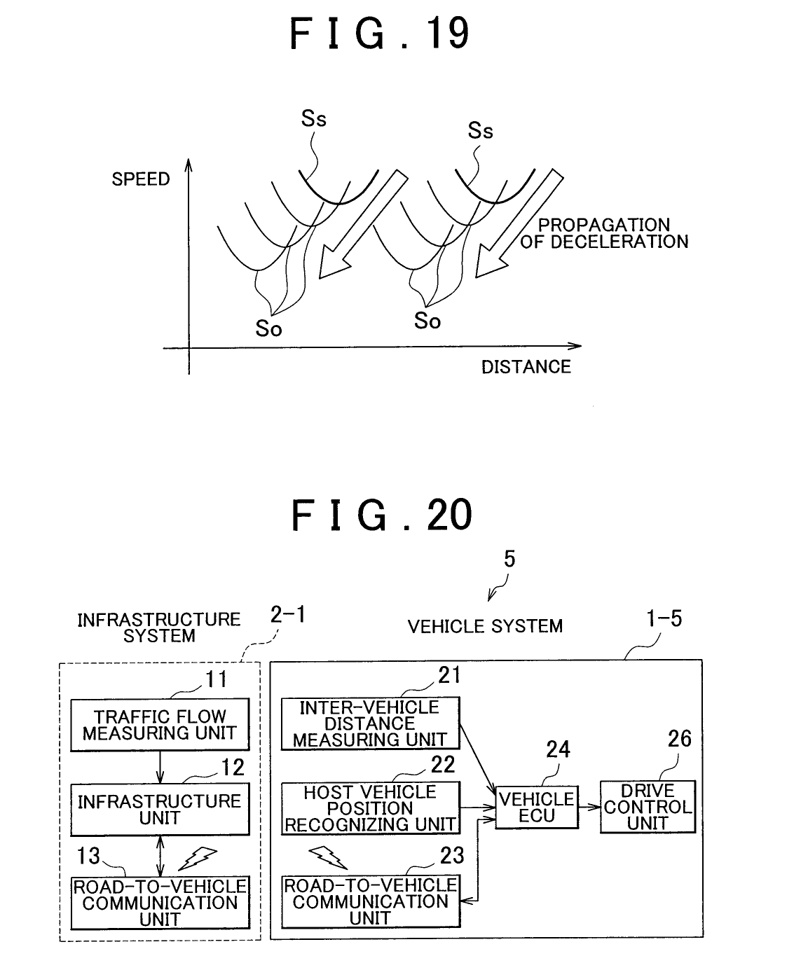

FIG. 18 shows a state where deceleration has propagated to the general vehicle CO₂ that is two vehicles behind the system-equipped vehicle CS12 and deceleration has not yet propagated to the immediately preceding vehicle Cpre. At this time point, the inter-vehicle distance L2 from the immediately preceding vehicle Cpre is increased from the inter-vehicle distance L1 at the time point shown in FIG. 17. In addition, the speed of the host vehicle CS13 is lower than the speed of the immediately preceding vehicle Cpre. Thus, as will be described with reference to FIG. 19, the vehicle system 1-4 that serves as the vehicle control device according to the second embodiment is able to cut off propagation of deceleration. FIG. 19 is a view that shows a state of propagation of deceleration when system-equipped vehicles and general vehicles mixedly travel. In FIG. 19, the reference signs Ss indicate changes in the speeds of the system-equipped vehicles, and the reference signs So indicate changes in the speeds of the general vehicles. Each system-equipped vehicle decelerates in coordination with deceleration of a preceding system-equipped vehicle. By so doing, as shown in FIG. 19, propagation of deceleration from forward is cut off by the system-equipped vehicle.

In the second embodiment, the target inter-vehicle distance for follow-up control is variable on the basis of the percentage of system-equipped vehicles that are equipped with the vehicle system 1-4 that is able to execute coordinated deceleration control. The vehicle ECU 24 reduces the target inter-vehicle distance when the percentage of system-equipped vehicles is high as compared with when the percentage of system-equipped vehicles is low. This is because of the following reason. The percentage of system-equipped vehicles may be, for example, calculated by the same method as the method of calculating the percentage of system-equipped vehicles in the second alternative embodiment to the first embodiment. Note that, when the vehicle control system 4 includes the same infrastructure system as the infrastructure system 2-1 according to the first embodiment, it is only necessary that the percentage of system-equipped vehicles is acquired from the infrastructure system.

When the percentage of system-equipped vehicles is low, there is a high possibility that the host vehicle CS13 and the preceding system-equipped vehicle CS12 travel with many general vehicles placed therebetween. As the number of general vehicles placed in between increases, it becomes hard to predict how deceleration propagates to the host vehicle CS13. For example, there is a case where general vehicles that travel between the host vehicle CS13 and the preceding system-equipped vehicle CS12 decelerate to thereby start propagation of deceleration. When there is no system-equipped vehicle that is traveling between the host vehicle CS13 and the general vehicle that has started deceleration, the host vehicle CS13 needs to start deceleration after deceleration has propagated to the host vehicle CS13. In addition, when deceleration propagates through many general vehicles, it requires time until deceleration propagates from the preceding system-equipped vehicle CS12 to the host vehicle CS13. Thus, there is a possibility that deceleration of the preceding system-equipped vehicle CS12 ends to end coordinated deceleration and then deceleration propagates to the host vehicle CS13 after the host vehicle CS13 gets close to the immediately preceding vehicle Cpre. In this way, there are many indefinite factors when the percentage of system-equipped vehicles is low, so it is desirable to have a margin in the target inter-vehicle distance.

When the percentage of system-equipped vehicles is high, there is a low possibility that the host vehicle CS13 and the preceding system-equipped vehicle CS12 travel with many general vehicles placed therebetween. Thus, there are small indefinite factors arising from the general vehicles. For example, there are many system-equipped vehicles that start deceleration in coordination with preceding system-equipped vehicles, so propagation of deceleration is cut off at various portions, and sparse or dense in a distribution of vehicles on a road is hard to occur. In addition, even when propagation of deceleration is started from a general vehicle that travels between the host vehicle CS13 and the preceding system-equipped vehicle CS12, the number of vehicles that are placed between that general vehicle and the host vehicle CS13 is small, so a situation that the host vehicle CS13 needs to decrease the speed by a large amount is hard to occur. Therefore, the target inter-vehicle distance may be reduced when the percentage of system-equipped vehicles is high as compared with when the percentage of system-equipped vehicles is low.

When the percentage of system-equipped vehicles is high, the vehicle ECU 24 reduces the target inter-vehicle distance, so the traffic capacity of the road increases. In addition, when the target inter-vehicle distance is small, it is advantageous that air resistance reduces to improve the fuel economy of each system-equipped vehicle.

In this way, with the vehicle control system 4 according to the second embodiment, it is possible to cut off propagation of deceleration through coordinated deceleration control, and the target inter-vehicle distance is reduced when the percentage of system-equipped vehicles is high to thereby make it possible to increase the traffic capacity and improve the fuel economy.

Note that information about deceleration of a preceding system-equipped vehicle is not limited to the immediately preceding vehicle speed Vₚᵣₑ. Information about deceleration may be information about deceleration operation conducted by the driver of a preceding system-equipped vehicle or information about deceleration control over the vehicle. For example, information about deceleration may be information about a brake operation amount, information about a brake control amount, information about shift operation, or the like.

Next, a third embodiment will be described. The third embodiment will be described with reference to FIG. 20 to FIG. 22. In the third embodiment, like reference numerals denote components having functions similar to those described in the first embodiment, and the overlap description is omitted.

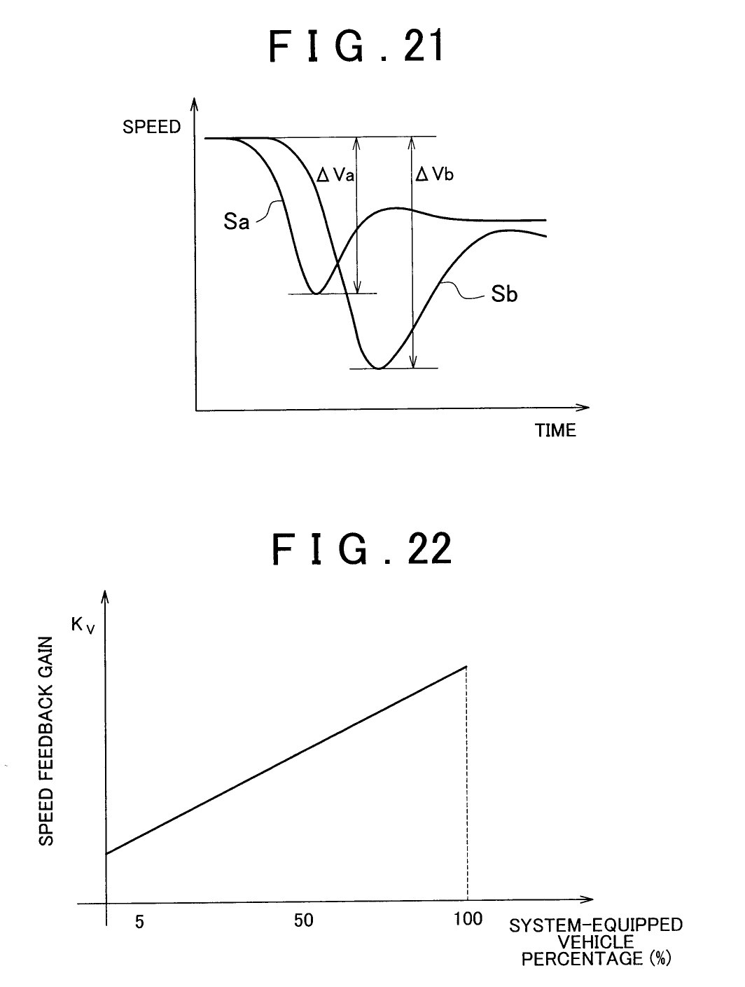

In the third embodiment, a feedback gain in follow-up control is variable on the basis of the percentage of system-equipped vehicles. A feedback gain when the percentage of system-equipped vehicles is high is larger than a feedback gain when the percentage of system-equipped vehicles is low, and then control that places importance on the stability of a vehicle group is executed. FIG. 20 is a block diagram that shows a vehicle control system 5 according to the third embodiment. FIG. 21 is a graph for illustrating a speed propagation ratio. FIG. 22 is a graph that shows the correlation between the percentage of system-equipped vehicles and a feedback gain.

As shown in FIG. 20, a vehicle system 1-5 according to the third embodiment includes a drive control unit 26 instead of the HMI unit 25 of the vehicle system 1-1 according to the first embodiment. The drive control unit 26 controls the driving state of the vehicle, and controls an engine, a brake, an automatic transmission, and the like. The vehicle ECU 24 is able to execute follow-up control that causes the host vehicle to travel following an immediately preceding vehicle that travels immediately ahead of the host vehicle so as to bring the inter-vehicle distance or inter-vehicle time between the host vehicle and the immediately preceding vehicle to a predetermined value. In follow-up control, the vehicle system 1-5 executes feedback control based on the relative vehicle speed between the host vehicle and the immediately preceding vehicle. The follow-up control is, for example, executed as one of control modes of ACC. The vehicle ECU 24, for example, calculates a host vehicle target acceleration aₜ in the follow-up control by the following mathematical expression (2).

aₜ=K_{V}×(Vₚᵣₑ−V)+K_{L}×(Lₜ−L) (2)

Here, K_{V} is a feedback gain of a speed difference from the immediately preceding vehicle, (Vₚᵣₑ−V) is a speed difference from the immediately preceding vehicle, K_{L} is a feedback gain of a deviation in inter-vehicle distance from the immediately preceding vehicle, and (Lₜ-L) is a deviation in inter-vehicle distance from the immediately preceding vehicle. In the third embodiment, the feedback gain K_{V} of a speed difference from the immediately preceding vehicle corresponds to a variable parameter.

The vehicle ECU 24 outputs the calculated host vehicle target acceleration aₜ to the drive control unit 26. The drive control unit 26 controls the engine, the brake, the automatic transmission, and the like, to achieve the host vehicle target acceleration aₜ.

In follow-up control, the way of propagation of deceleration varies depending on the feedback gain. In FIG. 21, the reference sign Sa indicates a speed change of an immediately preceding vehicle, and the reference sign Sb indicates a speed change of a vehicle that travels following the immediately preceding vehicle. In addition, the reference sign ΔVa indicates a decrease in the speed of the immediately preceding vehicle during deceleration, and the reference sign ΔVb indicates a decrease in the speed of the vehicle that travels following the immediately preceding vehicle. A speed propagation ratio γ in propagation of deceleration is expressed by the following mathematical expression (3).

Speed propagation ratio γ=ΔVb/ΔVa (3)

This indicates that, when the speed propagation ratio γ is larger than 1, the speed decrease ΔVb in the following vehicle is larger than the speed decrease ΔVa in the preceding vehicle, that is, a speed decrease ΔV is amplified and propagated to following vehicles. As the speed propagation ratio γ increases, a decrease in speed in propagation of deceleration increases and then stability of a vehicle group decreases to, for example, easily cause traffic congestion. On the other hand, as the speed propagation ratio γ reduces, a decrease in speed in propagation of deceleration reduces. When the speed propagation ratio γ is smaller than 1, the speed decrease ΔVb of the vehicle that travels following the immediately preceding vehicle is smaller than the speed decrease ΔVa of the immediately preceding vehicle, and propagation of deceleration is absorbed. Thus, when the speed propagation ratio γ may be reduced to below 1, it is possible to reduce generation of decelerating shock wave.

Here, the speed decrease ΔVb of the vehicle that travels following the immediately preceding vehicle varies with a follow-up traveling feedback gain. For example, when the feedback gain K_{V} of a speed difference from the immediately preceding vehicle (hereinafter, simply referred to as “speed difference feedback gain”) is increased, the drive control unit 26 generates a larger deceleration in response to deceleration of the immediately preceding vehicle. As a result, the speed decrease ΔVb of the vehicle that travels following the immediately preceding vehicle reduces as compared with when the speed difference feedback gain K_{V} is small. When the speed difference feedback gain K_{V} is determined so as to be able to set the speed propagation ratio γ below 1, it is possible not to decrease the speed with respect to that of the preceding vehicle or not to amplify and propagate a decrease in speed to following vehicles, that is, it is possible to stabilize a vehicle group.

The vehicle system 1-5 according to the third embodiment generates a host vehicle target acceleration that is variable on the basis of the percentage of system-equipped vehicles. The percentage of system-equipped vehicles may be, for example, acquired from the infrastructure system 2-1. As shown in FIG. 22, the vehicle ECU 24 sets the speed difference feedback gain K_{V} when the percentage of system-equipped vehicles is high so as to be larger than the speed difference feedback gain K_{V} when the percentage of system-equipped vehicles is low. By so doing, follow-up control when the percentage of system-equipped vehicles is low may be intended to place importance on ride comfort. Follow-up control when the percentage of the system-equipped vehicle is high may be intended to place importance on the stability of a vehicle group.

Note that a feedback gain that is variable on the basis of the percentage of system-equipped vehicles is not limited to the speed difference feedback gain K_{V}. Another feedback gain used to calculate a host vehicle target acceleration aₜ, such as an inter-vehicle distance deviation feedback gain K_{L}, may be variable on the basis of the percentage of system-equipped vehicles. In addition, a feedback gain may be variable on the basis of the density of vehicles on a road. For example, the rate of change in feedback gain against a change in the percentage of system-equipped vehicles may be increased when the density of vehicles is high as compared with when the density of vehicles is low. Furthermore, when the density of vehicles is low, a feedback gain may not be changed against a change in the percentage of system-equipped vehicles. For example, when a feedback gain is fixed to a small value when the density of vehicles is low, it is possible to improve ride comfort.

The correlation between the percentage of system-equipped vehicles and a feedback gain is not limited to the linear correlation shown in FIG. 22. For example, a feedback gain may be increased in a stepwise manner with an increase in the percentage of system-equipped vehicles. A parameter, such as the speed difference feedback gain K_{V}, may be generated by the infrastructure system 2-1 and then may be provided to each system-equipped vehicle.

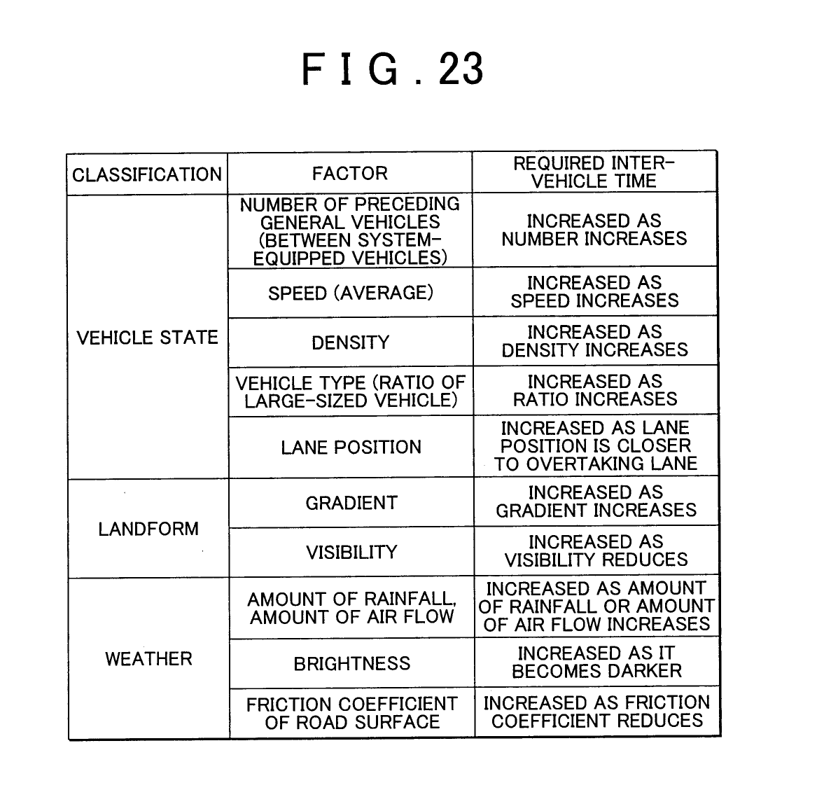

Next, a fourth embodiment will be described. The fourth embodiment will be described with reference to FIG. 23. In the fourth embodiment, like reference numerals denote components having functions similar to those described in the first embodiment, and the overlap description is omitted.

In the fourth embodiment, a target inter-vehicle time in follow-up traveling of each system-equipped vehicle is adjusted on the basis of information about the state of vehicles on a road, information about landform, information about weather, and the like. An assumed system-equipped vehicle is able to generate a target value associated with the inter-vehicle distance between the host vehicle and a vehicle traveling immediately ahead of the host vehicle, the target value being variable on the basis of acquired predetermined information, and is able to execute predetermined control that is drive control over the host vehicle based on the generated target value. The predetermined control is, for example, follow-up control that causes the host vehicle to travel following a vehicle that travels immediately ahead. The configuration of a vehicle system that serves as a vehicle control device may be, for example, the same as the vehicle system 1-5 according to the third embodiment; however, the vehicle system is not limited to it. A target inter-vehicle time may be similarly adjusted in the vehicle systems according to the other embodiments and alternative embodiments. Furthermore, a target inter-vehicle time may be adjusted not only in the vehicle systems described in the above embodiments and alternative embodiments but also in another vehicle system that is able to execute predetermined control as described below. In addition, the same infrastructure system 2-1 as that of the first embodiment may be installed on a road.

FIG. 23 is a table that shows the correlation between each factor and a required inter-vehicle time. A target inter-vehicle time based on a required inter-vehicle time corresponding to a factor is adjusted on the basis of at least one of information about weather, information about landform and information about the state of vehicles on a road. Each factor may be detected or estimated by the vehicle system or, when the infrastructure system 2-1 is provided, each factor may be detected or estimated by the infrastructure system 2-1. A target inter-vehicle time is, for example, adjusted by the vehicle ECU 24; instead, a target inter-vehicle time may be adjusted by the infrastructure unit 12. By way of example, a target inter-vehicle time is adjusted on the basis of a map that shows the correlation between the value of each factor and the correction amount of a target inter-vehicle time. When the target inter-vehicle time is adjusted by the vehicle ECU 24, the vehicle ECU 24 generates a target inter-vehicle time, which is variable on the basis of the value of each factor, by consulting the map, or the like. When the target inter-vehicle time is adjusted by the infrastructure unit 12, the infrastructure unit 12 transmits the target inter-vehicle time, which is adjusted on the basis of the factors or the correction value of the target inter-vehicle time, to each system-equipped vehicle through road-to-vehicle communication. The vehicle ECU 24 of each system-equipped vehicle sets the received target inter-vehicle time for the target inter-vehicle time of the host vehicle or corrects the target inter-vehicle time on the basis of the received correction value.

As shown in FIG. 23, a required inter-vehicle time is increased when the number of general vehicles that do not execute predetermined control and that are traveling between system-equipped vehicles is large as compared with when the number of general vehicles is small. As the number of general vehicles placed between the host vehicle and a preceding system-equipped vehicle closest to the host vehicle increases, the target inter-vehicle time is increased. By so doing, even when the number of general vehicles is large and deceleration has propagated to a system-equipped vehicle in a state where a speed decrease is amplified by a large amount, propagation of deceleration is easily absorbed. The number of general vehicles placed between the system-equipped vehicles may be, for example, estimated on the basis of the traffic flow acquired from the infrastructure system 2-1 and the positional information of the preceding system-equipped vehicle. The positional information of the preceding system-equipped vehicle may be, for example, acquired from the infrastructure system 2-1. The number of general vehicles placed between the host vehicle and the preceding system-equipped vehicle may be estimated on the basis of the inter-vehicle distance between the host vehicle and the preceding system-equipped vehicle and the traffic flow of that lane, that is, the vehicle density on that lane. Note that, when the system-equipped vehicles include an inter-vehicle communication unit, the number of general vehicles placed between the host vehicle and the preceding system-equipped vehicle may be estimated on the basis of the positional information of the preceding system-equipped vehicle, acquired through inter-vehicle communication, and the density of vehicles that travel around.

In addition, the target inter-vehicle time is increased when the travel speed is high as compared with when the travel speed is low. The travel speed as a factor is the travel speed of the host vehicle, the travel speed of vehicles on the same lane, the travel speed of vehicles that travel around the host vehicle, or the like. In addition, the travel speed may be the travel speed of a single vehicle or may be the average speed of a plurality of vehicles. The target inter-vehicle time is increased as the travel speed increases, so it is possible to favorably absorb propagation of deceleration.

The target inter-vehicle time is increased when the vehicle density on a road is high as compared with when the vehicle density is low. The vehicle density on a road may be, for example, calculated on the basis of the traffic flow measured by the traffic flow measuring unit 11 and the average speed of vehicles that travel on the road. Deceleration easily propagates when the vehicle density is high; however, the target inter-vehicle time is increased to thereby make it possible to sufficiently absorb propagation of deceleration by the system-equipped vehicles.

The target inter-vehicle time may be adjusted on the basis of the types of vehicles that travel on a road. For example, the target inter-vehicle time when the ratio (percentage) of large-sized vehicles is high is increased as compared with the target inter-vehicle time when the ratio of large-sized vehicles is low. For example, when the traffic flow measuring unit 11 that is able to detect vehicle length is used, it is possible to detect the ratio of large-sized vehicles on the basis of the results measured by the traffic flow measuring unit 11. Deceleration easily propagates when the ratio of large-sized vehicles is high; however, the target inter-vehicle time is increased to thereby make it possible to sufficiently absorb propagation of deceleration by the system-equipped vehicles.

The target inter-vehicle time may be adjusted on the basis of a lane position on a road on which the host vehicle travels. For example, the target inter-vehicle time may be increased as the lane is located closer to an overtaking lane. For example, when the right-side lane in the travel direction is an overtaking lane and the center and left-side lanes each are an inside lane in a six lane road, the target inter-vehicle time is the longest on the overtaking lane, and the target inter-vehicle time is the shortest on the left-side lane. Alternatively, it is also applicable that the target inter-vehicle time is common between the inside lanes and the target inter-vehicle time is longer on the overtaking lane than on the inside lanes. The target inter-vehicle time is increased on a lane adjacent to the overtaking lane, on which deceleration easily propagates, to thereby make it possible to sufficiently absorb propagation of deceleration by the system-equipped vehicles. Note that each system-equipped vehicle is able to determine the lane on which the host vehicle is traveling, for example, on the basis of the host vehicle positional information acquired from the host vehicle position recognizing unit 22 and road information.

The target inter-vehicle time may be adjusted on the basis of the gradient of a road. For example, the target inter-vehicle time when the host vehicle travels on a high gradient road is increased as compared with the target inter-vehicle time when the host vehicle travels on a low gradient road. The gradient of a road may be, for example, acquired from the host vehicle position recognizing unit 22. The target inter-vehicle time is increased on a high gradient road on which deceleration easily propagates to thereby make it possible to sufficiently absorb propagation of deceleration by the system-equipped vehicles.

The target inter-vehicle time may be adjusted on the basis of the condition of visibility. For example, the target inter-vehicle time when the host vehicle travels on a low visibility road is increased as compared with the target inter-vehicle time when the host vehicle travels on a high visibility road. The high or low visibility may be, for example, determined on the basis of information about a road shape, stored by the host vehicle position recognizing unit 22. The target inter-vehicle time is increased on a low visibility road on which deceleration easily propagates to thereby make it possible to sufficiently absorb propagation of deceleration by the system-equipped vehicles.

The target inter-vehicle time may be adjusted on the basis of the amount of rainfall or the amount of air flow. For example, the target inter-vehicle time may be increased when the amount of rainfall is large as compared with when the amount of rainfall is small. In addition, the target inter-vehicle time may be increased when the amount of air flow is large (the wind velocity is high) as compared with when the amount of air flow is small. Information about the amount of rainfall or the amount of air flow may be, for example, acquired from the infrastructure system 2-1. The target inter-vehicle time is increased in a situation that the amount of rainfall or the amount of air flow is large and deceleration easily propagates to thereby make it possible to sufficiently absorb propagation of deceleration by the system-equipped vehicles.

The target inter-vehicle time may be adjusted on the basis of brightness. For example, the target inter-vehicle time may be increased when it is dark as compared with when it is bright. The target inter-vehicle time is increased under a dark condition in which deceleration easily propagates to thereby make it possible to sufficiently absorb propagation of deceleration by the system-equipped vehicles.

The target inter-vehicle time may be adjusted on the basis of the friction coefficient of a road surface. For example, the target inter-vehicle time is increased when the friction coefficient is small as compared with when the friction coefficient is large. The target inter-vehicle time is increased under the weather in which the friction coefficient is small and deceleration easily propagates to thereby make it possible to sufficiently absorb propagation of deceleration by the system-equipped vehicles.

Note that, it is not limited to the ones illustrated in the fourth embodiment, but the target inter-vehicle time may be adjusted on the basis of another factor that influences the ease of propagation of deceleration.

The details described in the above embodiments may be implemented in combination where appropriate.

As described above, the vehicle control device, the vehicle control system and the traffic control system according to the aspects of the invention are suitable for appropriately setting a target value associated with the driving state of a vehicle.

1. A vehicle control device comprising:
a parameter generating unit that is configured to generate a parameter associated with a driving state of a vehicle, the parameter being variable on the basis of acquired predetermined information; and
a controller that is configured to execute predetermined control for carrying out at least one of drive control over the vehicle based on the parameter and provision of information to a driver to assist achieving the parameter with driving operation, wherein
the predetermined information is the percentage of predetermined vehicles that are equipped with the parameter generating unit and the controller.

2. The vehicle control device according to claim 1, wherein
the percentage of the predetermined vehicles is based on the penetration rate of the predetermined vehicles.

3. The vehicle control device according to claim 1, wherein
the percentage of the predetermined vehicles is an estimated or detected percentage of the predetermined vehicles in vehicles that are actually traveling on a road.

4. The vehicle control device according to any one of claims 1 through 3, wherein
the parameter is a value associated with an inter-vehicle distance between a host vehicle and a vehicle that travels immediately ahead of the host vehicle.

5. The vehicle control device according to claim 4, wherein
the parameter generating unit is configured to generate a target value associated with the inter-vehicle distance on the basis of the density of vehicles that travel on a road and the percentage of the predetermined vehicles, and the target value when the vehicle density is high is larger than the target value when the vehicle density is low.

6. The vehicle control device according to claim 5, wherein
the parameter generating unit is configured to calculate a first target value, which is a target of a value associated with the inter-vehicle distance, on the basis of the vehicle density, and is configured to generate the target value by guarding the first target value with an upper limit value that is variable on the basis of the percentage of the predetermined vehicles.

7. The vehicle control device according to claim 6, wherein
a correlation between the percentage of the predetermined vehicles and the upper limit value is based on a correlation between the percentage of the predetermined vehicles in vehicles that travel on a road and a traffic flow at which vehicles are travelable on the road when each of the predetermined vehicles travels while keeping the value associated with the inter-vehicle distance.

8. The vehicle control device according to claim 6 or 7, wherein
the upper limit value when the percentage of the predetermined vehicles is high is smaller than the upper limit value when the percentage of the predetermined vehicles is low.

9. The vehicle control device according to claim 4, wherein
the parameter generating unit is configured to generate a target value, which is the value associated with the inter-vehicle distance, as the parameter, and
each of the predetermined vehicles is configured to be able to acquire information about deceleration of a preceding predetermined vehicle, which is at least one of the predetermined vehicles that travel ahead of the host vehicle, from the preceding predetermined vehicle to decelerate the host vehicle in synchronization with the deceleration of the preceding predetermined vehicle on the basis of the information about the deceleration, and the target value when the percentage of the predetermined vehicles is high is smaller than the target value when the percentage of the predetermined vehicles is low.

10. The vehicle control device according to any one of claims 1 through 3, wherein
the controller is configured to execute feedback control, as the drive control, based on a relative vehicle speed with respect to a vehicle that travels immediately ahead of a host vehicle so as to bring a value associated with an inter-vehicle distance between the host vehicle and the vehicle that travels immediately ahead of the host vehicle to a predetermined value, and
the parameter is a feedback gain of the feedback control, and the feedback gain when the percentage of the predetermined vehicles is high is larger than the feedback gain when the percentage of the predetermined vehicles is low.

11. A vehicle control system comprising:
a traffic control system that is configured to be installed on a road and that is configured to generate a parameter associated with a driving state of a vehicle, the parameter being variable on the basis of acquired predetermined information; and
a vehicle control device that is configured to acquire the parameter from the traffic control system, and that is configured to execute predetermined control for carrying out at least one of drive control over the vehicle based on the parameter and provision of information to a driver to assist achieving the parameter with driving operation, wherein the predetermined information is the percentage of predetermined vehicles that execute the predetermined control.

12. A traffic control system comprising:
a parameter generating unit that is configured to be installed on a road and that is configured to generate a parameter associated with a driving state of a vehicle, the parameter being variable on the basis of acquired predetermined information; and
a parameter providing unit that is configured to provide the parameter to predetermined vehicles that execute predetermined control for carrying out at least one of drive control over the vehicle based on the parameter and provision of information to a driver to assist achieving the parameter with driving operation, wherein
the predetermined information is the percentage of the predetermined vehicles.

13. A vehicle control device comprising:
a target value generating unit that is configured to generate a target value associated with an inter-vehicle distance between a host vehicle and a vehicle that travels immediately ahead of the host vehicle, the parameter being variable on the basis of acquired predetermined information; and
a controller that is configured to execute predetermined control, which is drive control over the host vehicle based on the target value, wherein
the predetermined information includes at least one of information associated with weather, information associated with landform and information associated with a state of vehicles on a road.

14. The vehicle control device according to claim 13, wherein
the information associated with weather includes information associated with the friction coefficient of a road surface.

15. The vehicle control device according to claim 13, wherein
the information associated with a state of vehicles on a road includes at least one of the number of vehicles that travel ahead of the host vehicle and that do not execute the predetermined control, the speed of the vehicles on the road, the density of the vehicles on the road, the percentage of large-sized vehicles in the vehicles on the road and a lane position on the road on which the host vehicle travels.
